(19) United States
(12) Patent Application Publication
(10) Pub. No.: US 2005/0213504 A1
(43) Pub. Date: Sep. 29, 2005

(54) Information relay apparatus and method for collecting flow statistic information

(76) Inventors: Hiroshi Enomoto, Toyota (JP); Takeshi Aimoto, Sagamihara (JP); Shinichi Akahane, Hachioji (JP); Hidemitsu Higuchi, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/062,832

(22) Filed: Feb. 23, 2005

(30) Foreign Application Priority Data
Mar. 25, 2004 (JP) 2004-088302

(51) Int. Cl. H04L 1/00

(52) U.S. Cl. 370/235

(57) ABSTRACT

A flow dubious of an abnormal flow is asked to be specified and flow statistic information of the flow is required to be collected. To comply with such a request, a discard information analyzer of apparatus administrator, for instance, analyzes the number of discard packets, the number of receiving packets or the number of transmitting packets counted by a bandwidth monitor of packet receiver or a bandwidth controller of packet transmitter and in accordance with the result of analysis, automatically sets, in an OUT side flow controller or In side flow controller, information for identifying a flow subject to flow control. Further, the OUT side flow controller or IN side flow controller picks flow statistic information from packets belonging to the object flow by using the set flow identification information.

### INCORPORATION BY REFERENCE

The present application claims priority from Japanese application JP 2004-088302 filed on Mar. 25, 2004, the content of which is hereby incorporated by reference into this application.

### BACKGROUND OF THE INVENTION

The present invention relates to information relay technologies and more particularly, to techniques effectively applicable to an information relay apparatus such as router and LAN switch.

The information relay apparatus, for example, a router or LAN switch settles a transmission (send-out) route of a receiving packet in accordance with an address for Internet in the receiving packet and a route information table stored in the information relay apparatus and then transmits (sends out) the packet.

Recently, in a public network or an access network (for example, local IP network) provided by a communication enterprise (for example, ISP (Internet Service Provider)) as a connection network to the Internet, the personal circuit has been shifting progressively to a wide-area Ethernet (registered trademark), so that the communication amount of packets and the number of users utilizing the access network have been increasing drastically. The information relay apparatus increases the number of accommodated high-speed Ethernet circuits (hereinafter simply referred to as circuits) having a bandwidth of, for example, 10 Gbps (Giga bit per second) to have the function of dealing with a process for relaying packets at very high speeds.

With a view of assuring a contract bandwidth such as the minimum warrantable bandwidth for each user utilizing the network (hereinafter simply referred to as a user) in the wide-area Ethernet in which packets are transferred with best effort, the information relay apparatus also have the function to discard a packet flow exceeding a permissible bandwidth for each user by a limited number of packets in excess of the bandwidth. With the function as above, the information relay apparatus prevents the influence due to congestion of packets in the network upon communication bandwidths of other users, thereby observing or complying with the contract bandwidths made with individual users. Further, an information relay apparatus in a unified network for communication of voice and data also has the function of transferring data at different priority degrees in respect of individual types of applications for transmission/reception of data in the form of packets (hereinafter called packet applications). In this manner, the information relay apparatus decides a transfer priority degree referenced to a criterion predetermined in respect of each packet application so that a packet of voice for which transfer with a small delay is required may be transferred preferentially over a packet of data for which a relatively large delay is permitted.

A technique called shaping is described in JP-A-2002-185459, according to which a packet exceeding a permissible bandwidth for each user is limited or packets are transferred at transfer priority degrees which differ for the individual packet application types. It will be appreciated that an apparatus for execution of shaping is called a shaper.

The shaper is located in the information relay apparatus arranged at the outlet of a public network or access network (hereinafter referred to as a communication network), the outlet being the boundary between the communication network and a user network. The shaper manages pieces of contract bandwidth information such as the minimum warrantable bandwidths or maximum permissible bandwidths settled by contracts made between an administrator of the communication network (hereinafter referred to as a network administrator) and users user by user. Then, in the event that the utilization bandwidth utilized by an arbitrary user exceeds the maximum permissible bandwidth, for instance, the shaper discards packets by only a surplus amount. Through this, the communication bandwidth is so limited as not to exceed the maximum permissible bandwidth in respect of each user to prevent the communication bandwidth of anther user from being interfered, thereby assuring the minimum warrantable bandwidth of each user. On the other hand, the shaper distributes impartially remaining bandwidths of circuits to the individual users by taking the contracted minimum warrantable bandwidths and use conditions of network resources into account in order that the circuits can be utilized efficiently. Also, the shaper prepares a plurality of virtual communication paths of different transfer priority degrees in respect of the individual users and distributes packets to the virtual communication paths in accordance with the packet applications, with the result that packets can be transmitted at transfer priority degrees which differ for the individual packet applications. Through this, the minimum bandwidth can be guaranteed in respect of every user in contract and the quality required for each packet can be assured. The distribution of packets can be materialized by providing a plurality of transmission queues of different transfer priority degrees at, for example, a transmitter of the shaper and distributing the packets to these transmission queues.

In the event that a packet or packets in excess of the contract bandwidth flow into the communication network, for instance, congestion occurs in the network or information relay apparatus and there is a possibility that the network administrator cannot observe or comply with the contract bandwidths made with the individual users. Therefore, it is necessary for the network administrator to monitor the use bandwidths user by user for the purpose of performing a process of, for example, discarding packets in excess of the contract bandwidths, thereby protecting resources in the network. Available as means for this purpose is a technique called UPC (Usage Parameter Control) or policing described in JP-A-2003-046555, for instance. To add, an apparatus for executing the UPC or policing is herein called a policer.

The policer is located in the information relay apparatus arranged in the inlet to the communication network (the boundary between user network and communication network). For example, available as an algorithm for bandwidth monitor by the policer is a LB (Leaky Bucket) algorithm represented by a model using a bored leaky bucket having a depth. The information relay apparatus for performing bandwidth monitor by using the LB algorithm as the policer has cumulative amount threshold value information corresponding to the depth of the bucket, monitor bandwidth information indicative of a water leaking speed and corresponding to a contract bandwidth and preceding packet arrival time information indicative of a time at which a preceding packet arrived and calculates a cumulative amount of packets inclusive of a length of a receiving packet added when the packed is received, whereby the apparatus carries out monitoring of violation of contract bandwidth by determining the receiving packet as “compliance” when the cumulative amount is below the threshold value information but conversely as “violation” when the cumulative amount exceeds the threshold value information.

Further, with the communication amount increased and the packet application type diversified, the network administrator asks for the managing function such as monitoring and function to grasp utilization amounts in the communication network and money charging according to utilization amounts. In order to respond to these requirements, the information relay apparatus has, as the function of monitoring traffic in the communication network, the flow statistic function to collect statistic information (flow statistic information) of packets to be relayed. Here, “flow” indicates a series of packets transmitted and received in order to transmit arbitrary data between an arbitrary source and an arbitrary destination. The network administrator can afford to grasp use conditions of the communication network and utilization conditions of each user on the basis of flow statistic information collected by virtue of the flow statistic function. Available as the flow statistic function as above is, for example, an sFlow technology described in RFC (Request for Comment) 3176 “InMon Corporation's sFlow; A Method for Monitoring Traffic in Switched and Router Networks” published by IETF (The Internet Engineering Task Force), for instance.

For example, according to the sFLow technology, a flow sample for collecting transfer packet information and a counter sample for grasping a transfer packet number (the number of packets to be transferred) are picked up individually as flow statistic information. In picking the flow sample, the information relay apparatus extracts feature information pieces, for example, header information pieces from relayed packets at predetermined sampling intervals. Also, the information relay apparatus has, in an interface to the communication network, a counter for counting the number of packets to be transferred and picks a counter sample by adding a count value each time that the apparatus transfers a packet. The thus picked sample is transmitted from the information relay apparatus to, for example, a flow analyzer on real time base. The flow analyzer has the function of totaling, editing and displaying the samples transmitted from the information relay apparatus. The network administrator analyzes the samples of packets the information relay apparatus relays by using the flow analyzer so as to grasp use conditions of the communication network and utilization conditions by each user and utilize the results of analysis for money charge, attack analysis or planning of equipment investment to the communication network. It should be understood that all of the packets the information relay apparatus relays are objects of sample picking in the sFlow technique. Therefore, the network administrator can grasp conditions of a flow relayed by the information relay apparatus more accurately. In addition, by setting the sampling intervals for packets to, for example, 1/1, the information relay apparatus can pick flow samples in respect of all of the packets.

### SUMMARY OF THE INVENTION

As the widespread use of the Internet proceeds, an attack (DoS (Denial of Service)) takes place frequently in which a great deal of illegal packets is sent to the communication network or a server to impose an excessive load on it for the purpose of stopping communication service. In the wide-area Ethernet network performing relay operations with best effort, network resources are occupied with a great deal of illegal packets supplied through the DoS attack and the communication bandwidths of users utilizing circuits or the information relay apparatus are interfered. In order to protect the communication bandwidth of each user from a flow violative of bandwidth, that is, an abnormal flow, the aforementioned shaper is effective. When illegal packets are sent by a great deal from a predetermined source (attacker) to a predetermined destination (attacked destination), the shaper can limit the bandwidth utilized by an abnormal flow and consequently can assure communication bandwidths of other users. In this case, however, the communication bandwidths for other normal flows forwarded to the attacked destination are hindered.

Further, when a great deal of illegal packets are transmitted from a plurality of attackers to a single attacked destination as in the case of a DDoS (Distributed DoS attack) the occurrence of which has been increasing recently, an abnormal flow from one attacker behaves as a normal flow but as a whole a great deal of illegal packets are sent to the attacked destination. To cope with such an attack, the network administrator must specify the attacker and the attacked destination, specify feature information of the abnormal flow and take countermeasures against the abnormal flow. For the sake of identifying the attacked destination or attacker in the DoS attack or DDOS attack as above, the aforementioned flow statistic technique is effective. By analyzing samples collected through the use of the flow statistic function the information relay apparatus has, the network administrator finds out an abnormal flow which is sent by a great deal to the specified destination to thereby specify the attacker, attacked destination and feature information of the abnormal flow. Further, a packet having the same source, destination and other feature information as those of the specified flow is so set in the information relay apparatus as to be discarded. In this manner, countermeasures against the abnormal flow in the communication network can be taken.

Besides, by setting the permissible bandwidth for the abnormal flow to a smaller bandwidth in the shaper, the influence of a DoS attack can be lessened in the communication network.

It is however unpredictable in advance of start of an attack which source an abnormal flow is sent from and which destination the abnormal flow is sent to. Therefore, in order that the abnormal flow can be specified immediately at the attack start time point, sample picking of all relay packets must always be carried out on the basis of the flow statistic function of the information relay apparatus and flow monitor work using the flow analyzer must always be done by the network administrator. But, because of an increased number of accommodated high-speed circuits of, for example, 10 Gbps and an increased number of users, the information relay apparatus processes a great deal of normal packets and hence the amount of picked samples is large. Accordingly, the network administrator must analyze a great deal of samples and consumes much time to specify a small number of abnormal flows from flows relayed by means of the information relay apparatus. Consequently, there arises a problem that the network administrator cannot specify the abnormal flow immediately and cannot take countermeasures thereagainst.

Accordingly, the present invention provides an information relay apparatus which can reduce the amount of information pieces to be analyzed by the network administrator by detecting automatically congestion due to an abnormal flow and picking flow statistic information automatically only when the congestion takes place.

Also, this invention provides an information relay apparatus which can make the network administrator easily analyze the flow statistic information and specify the abnormal flow by extracting feature information of the abnormal flow to automatically narrow down flows and picking flow statistic information only in respect of the narrowed-down flows.

Further, this invention provides an information relay apparatus which can automatically perform setting such as discard in respect of a specified abnormal flow.

An information relay apparatus according to the invention comprises a bandwidth monitor for executing policing in respect of receiving packets and counting the number of packets which are so determined as to violate contract bandwidths made with individual users, or a bandwidth controller for executing shaping in respect of transmitting packets and counting the number of packets which are so determined as to violate contract bandwidths made with individual users. The information relay apparatus further comprises a flow controller for detecting, from receiving or transmitting packets, a packet having in its header information coincident with flow identification information registered in advance and collecting flow statistic information, and an analyzer for registering in the flow controller, when the number of packets counted by the bandwidth monitor or bandwidth controller exceeds a predetermined threshold value, information for identifying a flow to which the packets belong. In the information relay apparatus, the flow controller detects packets belonging to the flow, in which the number of the packets so determined as to violate contract bandwidths by means of the band monitor or bandwidth controller exceeds the predetermined threshold value, by using the flow identification information registered by the analyzer and collects the flow statistic information from the detected packets.

Since the information relay apparatus specifies, from flows in which packets are discarded owing to, for example, occurrence of congestion, a flow in which the discard number is abnormal and picks flow statistic information concerning the abnormal flow, the flow statistic analyzer receiving the flow statistic information from the information relay apparatus can analyze the abnormal flow relayed by the information relay apparatus, thereby ensuring that an abnormal flow or contract bandwidth violative flow taken advantage of by a DoS attack or DDOS attack can be specified more easily or more speedily.

### BRIEF DESCRIPTION OF THE DRAWINGDS

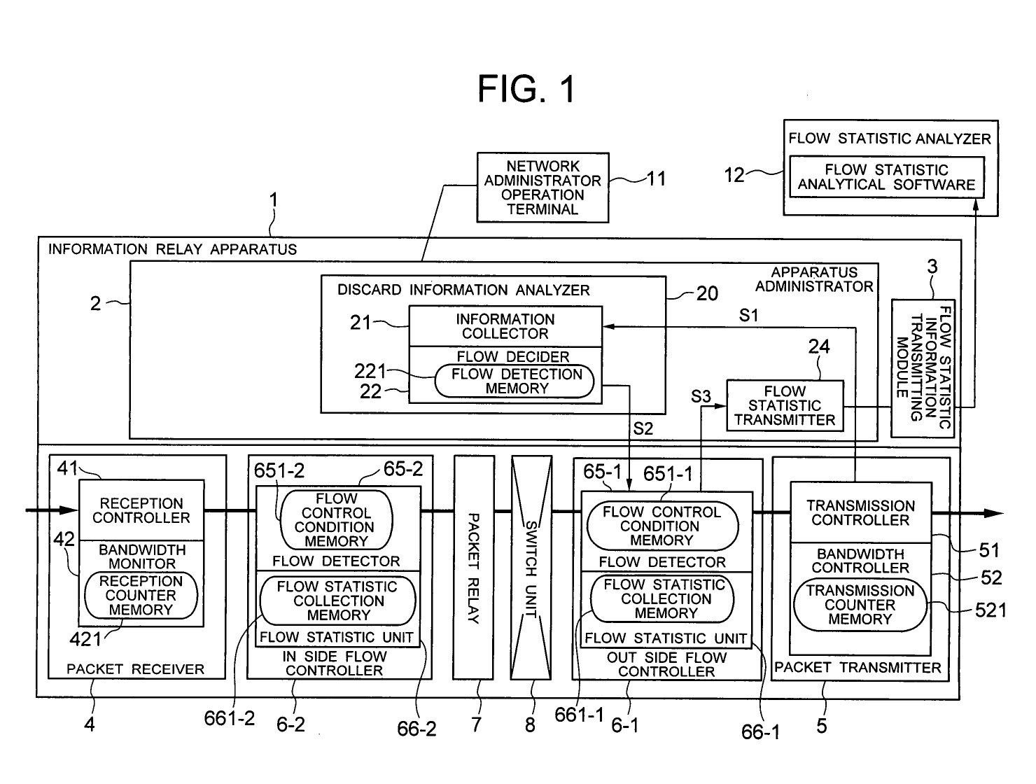

FIG. 1 is a bock diagram showing the overall construction of an information relay apparatus according to an embodiment of the invention.

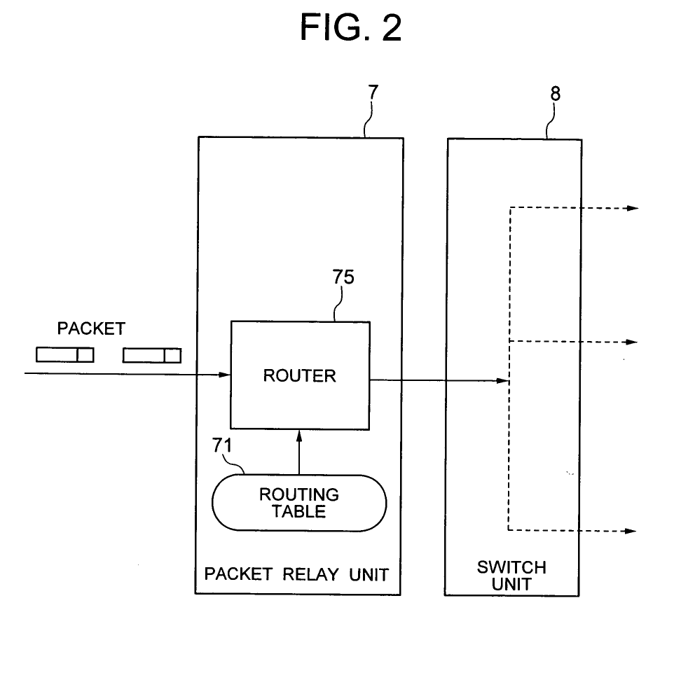

FIG. 2 is a block diagram showing an example of construction of packet relay unit 7 and switch unit 8 in FIG. 1 apparatus.

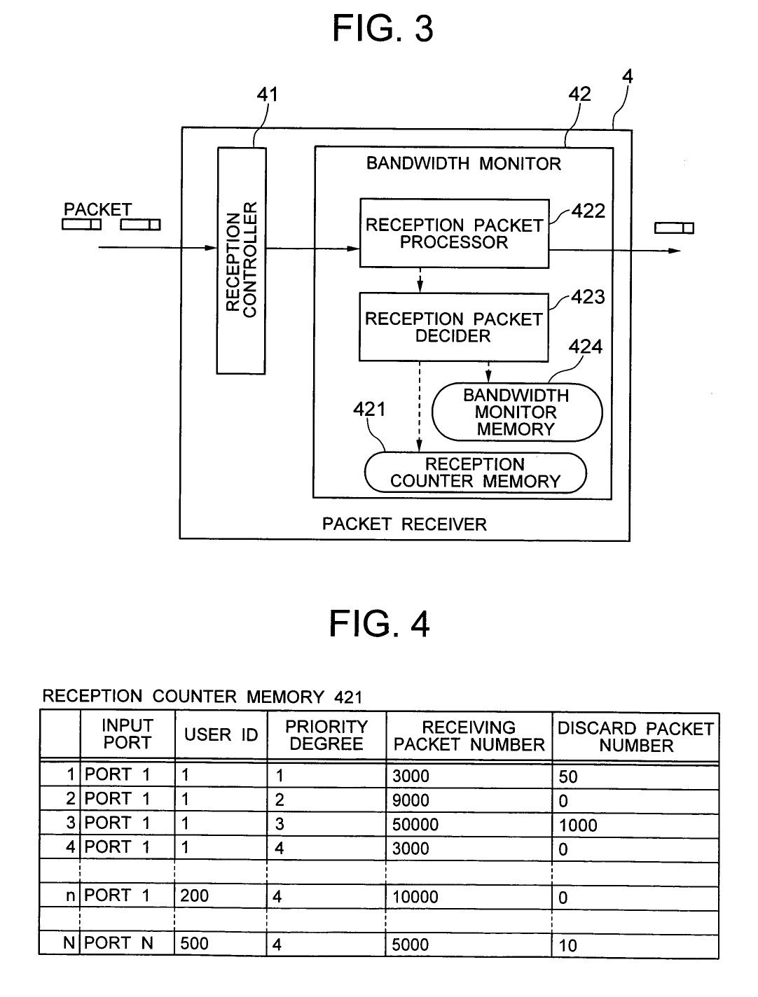

FIG. 3 is a block diagram showing an example of construction of packet receiver 4 in FIG. 1 apparatus.

FIG. 4 is a diagram showing an example of pieces of information stored in reception counter memory 421 of the packet receiver 4.

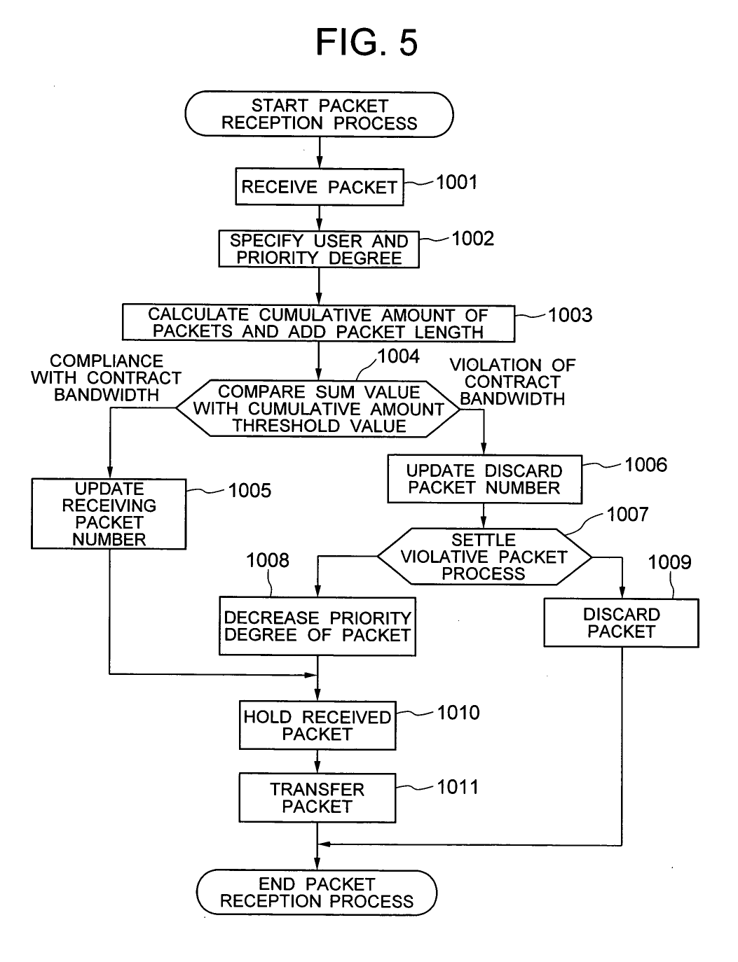

FIG. 5 is a flowchart showing an example of procedures in the packet receiver 4.

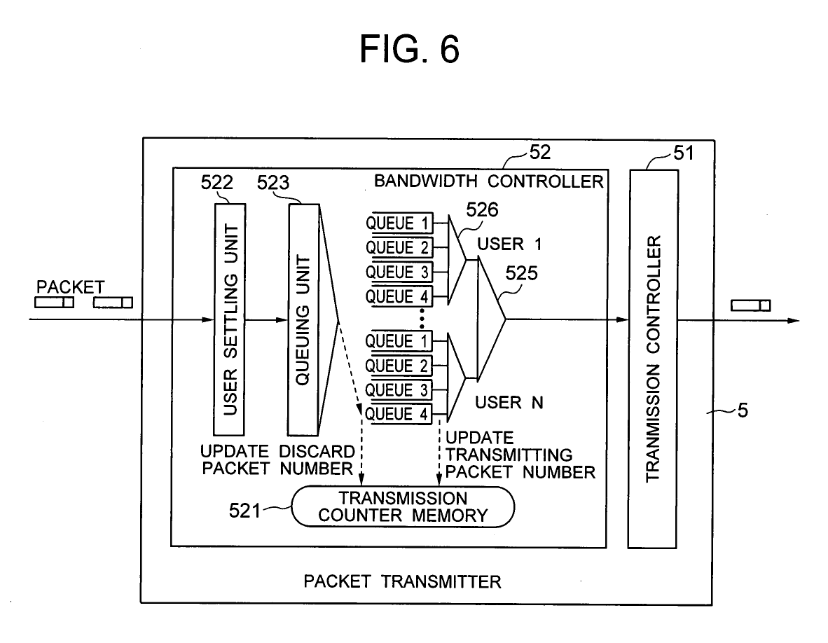

FIG. 6 is a block diagram showing an example of construction of packet transmitter 5 in the FIG. 1 apparatus.

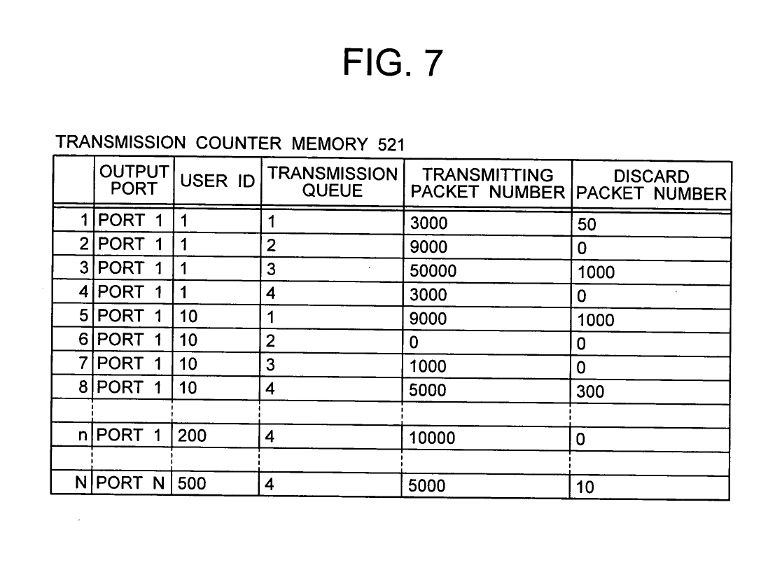

FIG. 7 is a diagram showing an example of pieces of information stored in transmission counter memory 521 of the packet transmitter 5.

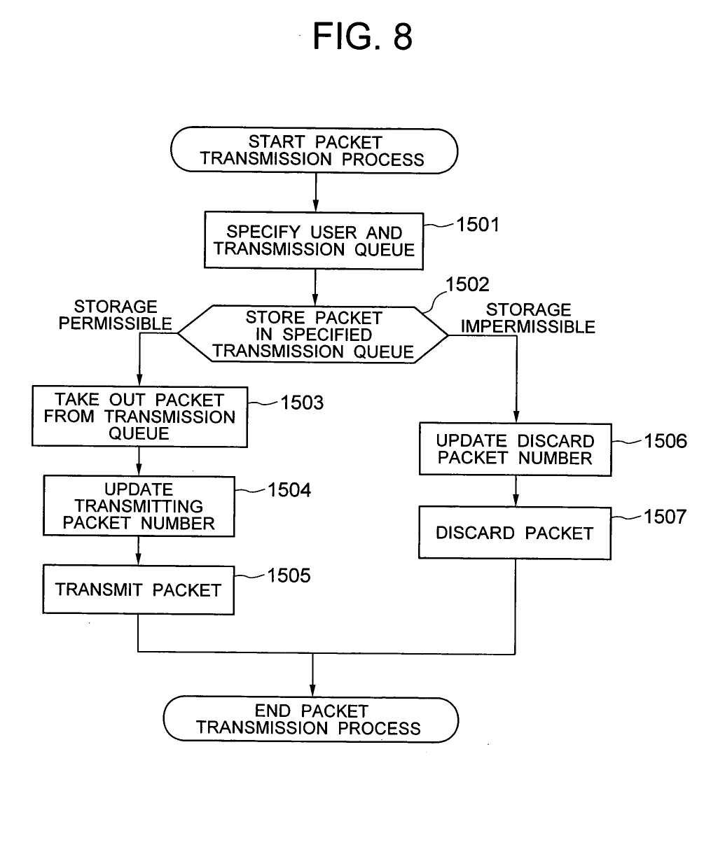

FIG. 8 is a flowchart showing an example of procedures in the packet transmitter 5.

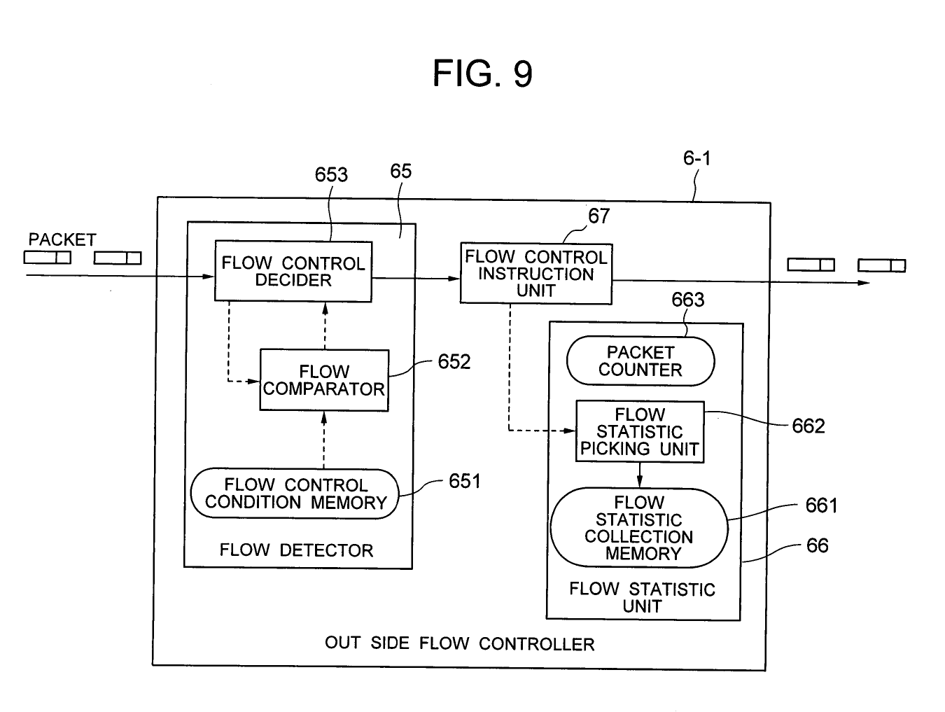

FIG. 9 is a block diagram showing an example of construction of OUT side flow controller 6-1 in the FIG. 1 apparatus.

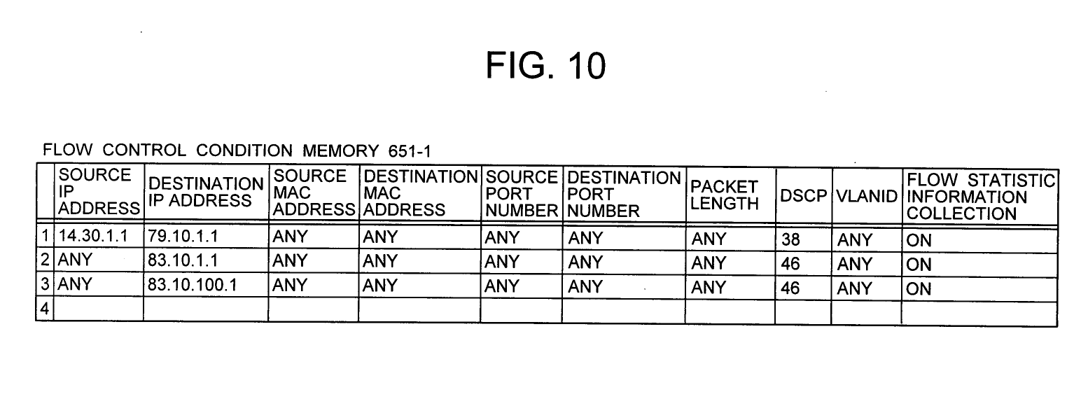

FIG. 10 is a diagram showing an example of pieces of information stored in OUT side flow control condition memory 651-1 of the OUT side flow controller 6-1.

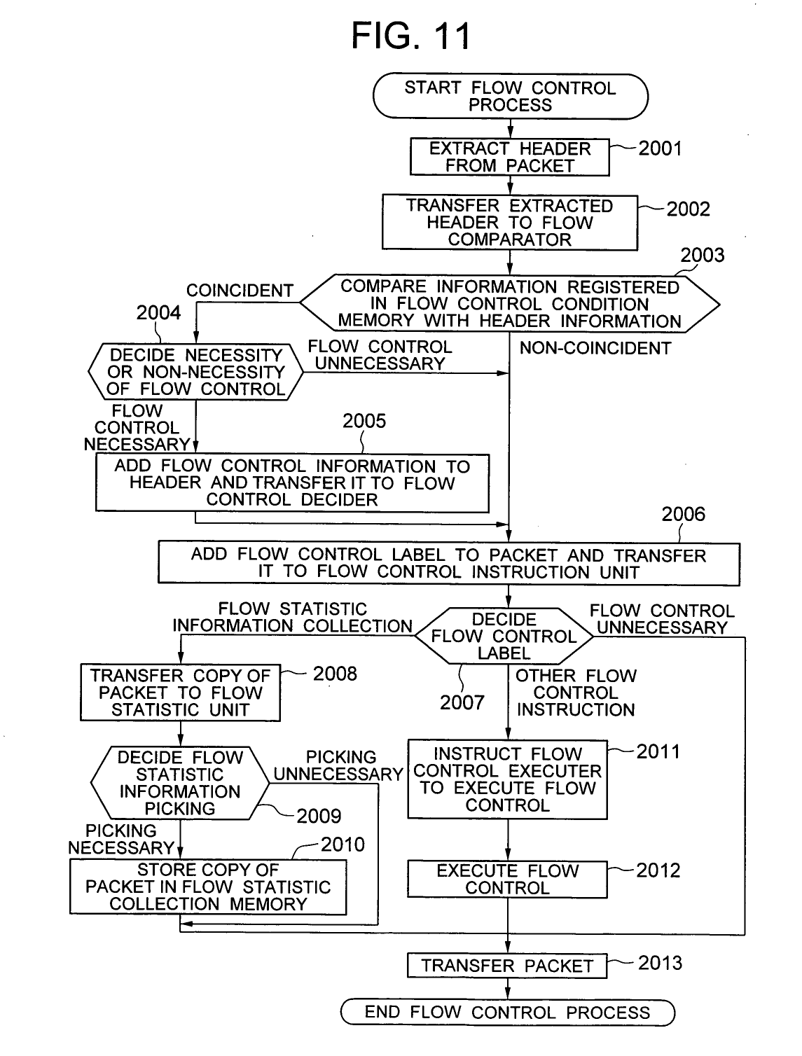

FIG. 11 is a flowchart showing an example of procedures in the OUT side flow controller 6-1.

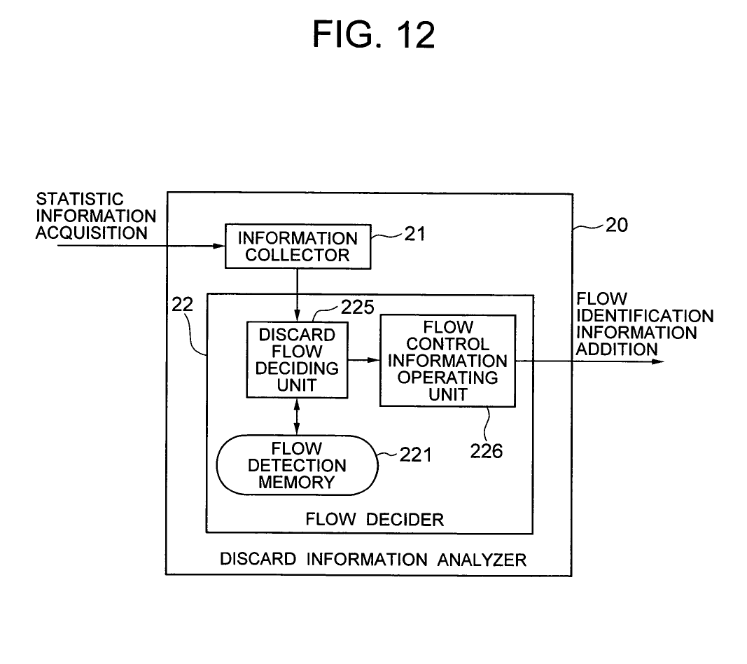

FIG. 12 is a block diagram showing an example of construction of discard information analyzer 20 in the FIG. 1 apparatus.

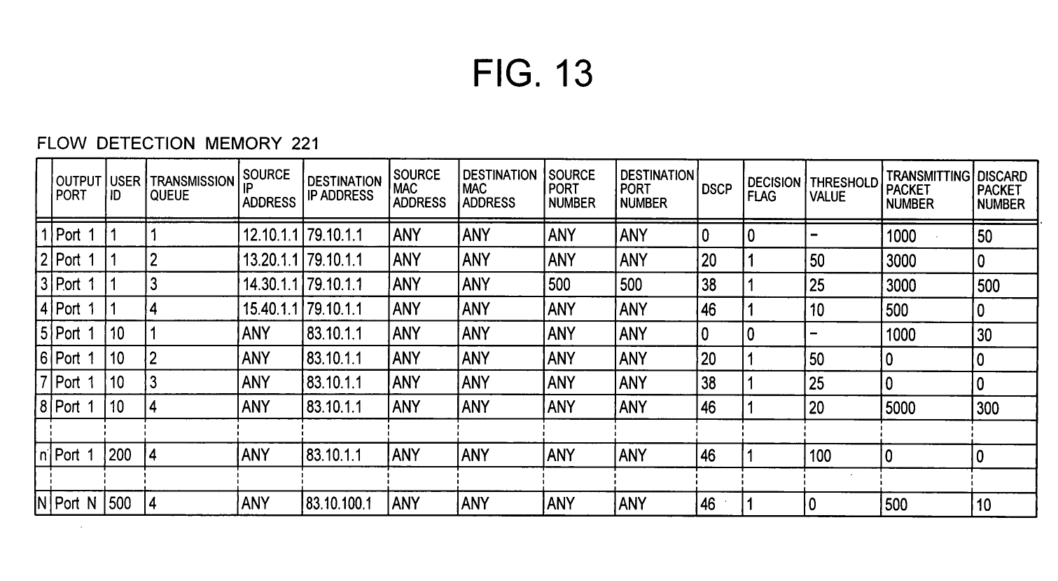

FIG. 13 is a diagram showing an example of pieces of information stored in flow detection memory 221 of the discard information analyzer 20.

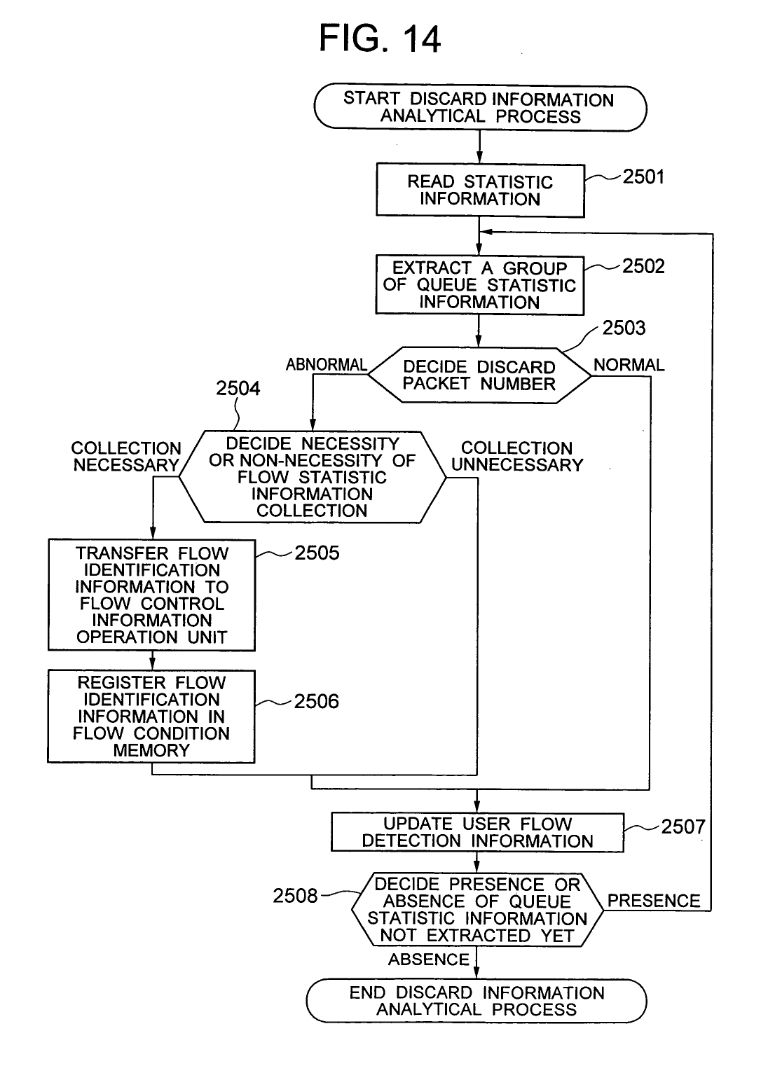

FIG. 14 is a flowchart showing an example of procedures in the discard information analyzer 20.

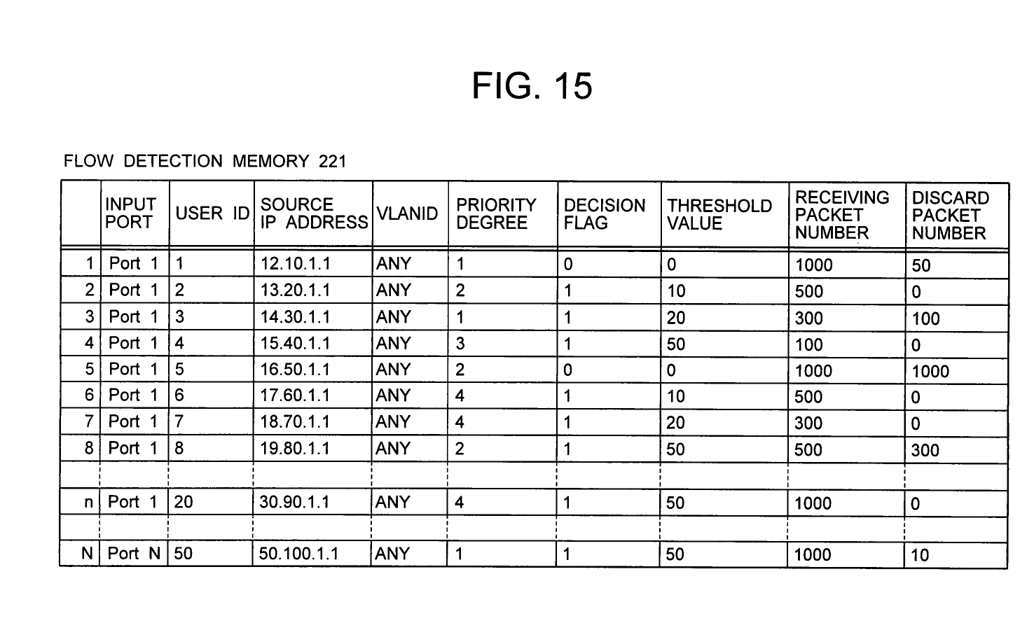

FIG. 15 is a diagram showing another example of pieces of information stored in the flow detection memory 221.

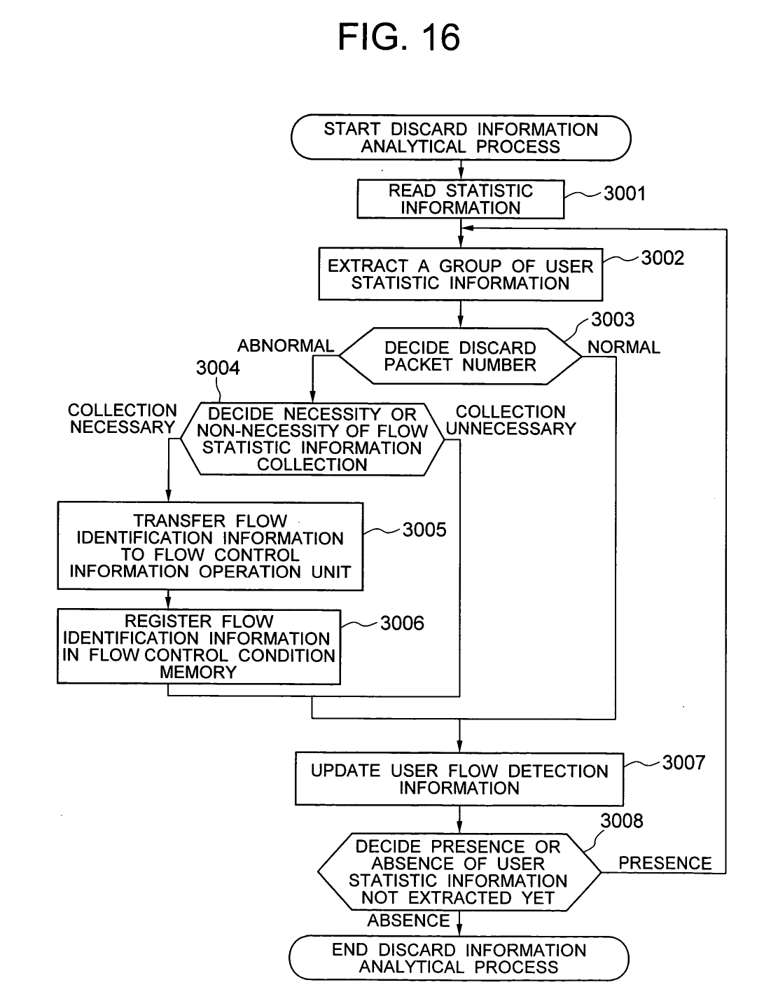

FIG. 16 is a flowchart showing another example of procedures in the discard information analyzer 20.

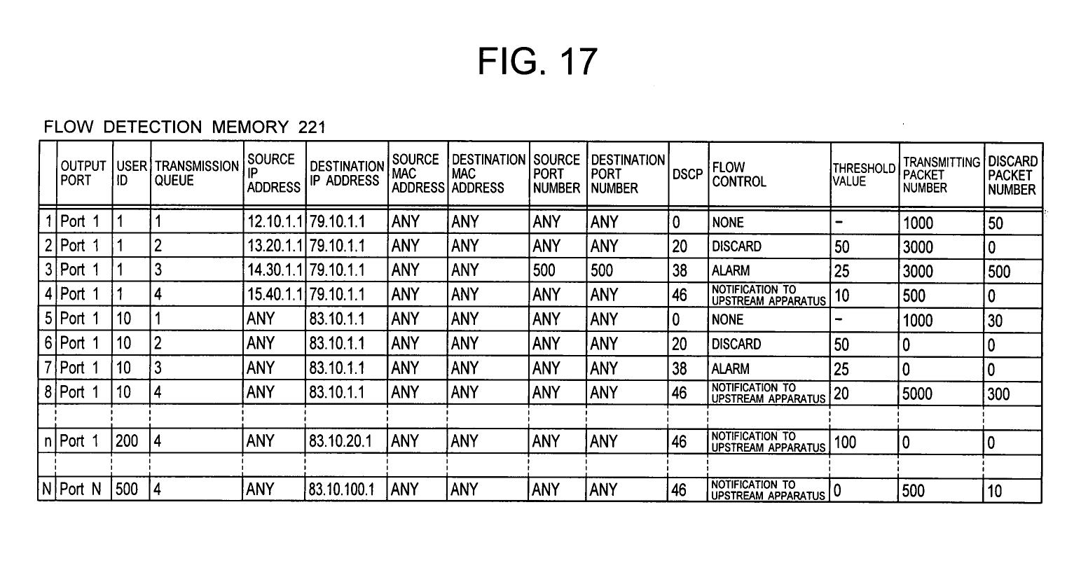

FIG. 17 is a diagram showing still another example of pieces of information stored in the flow detection memory 221.

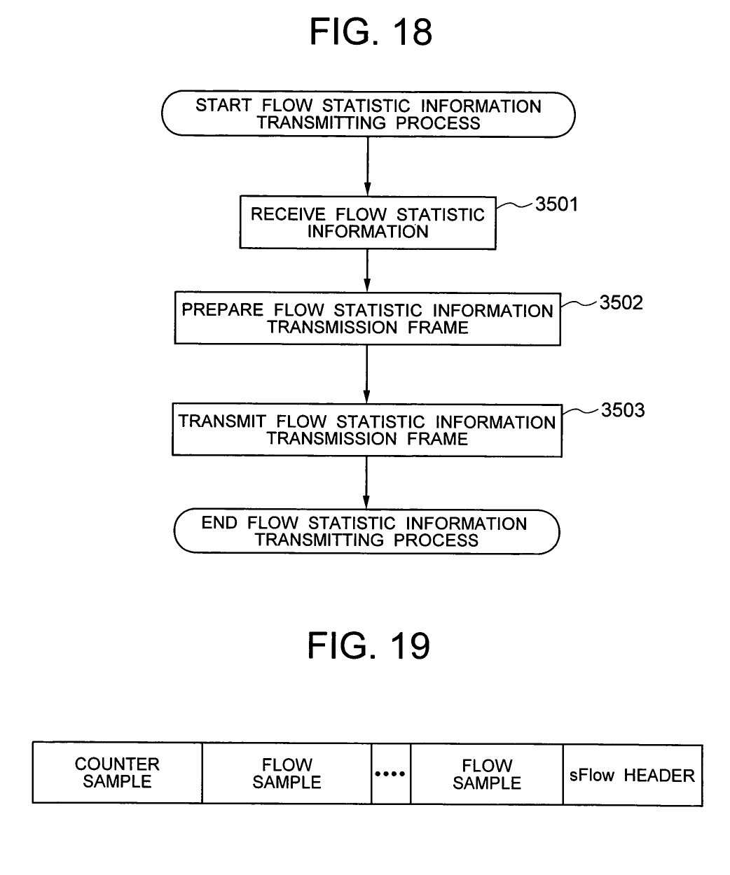

FIG. 18 is a flowchart showing an example of procedures in flow statistic transmitter 24 in the FIG. 1 apparatus.

FIG. 19 is a diagram showing an example of a format of flow statistic information transmission frame.

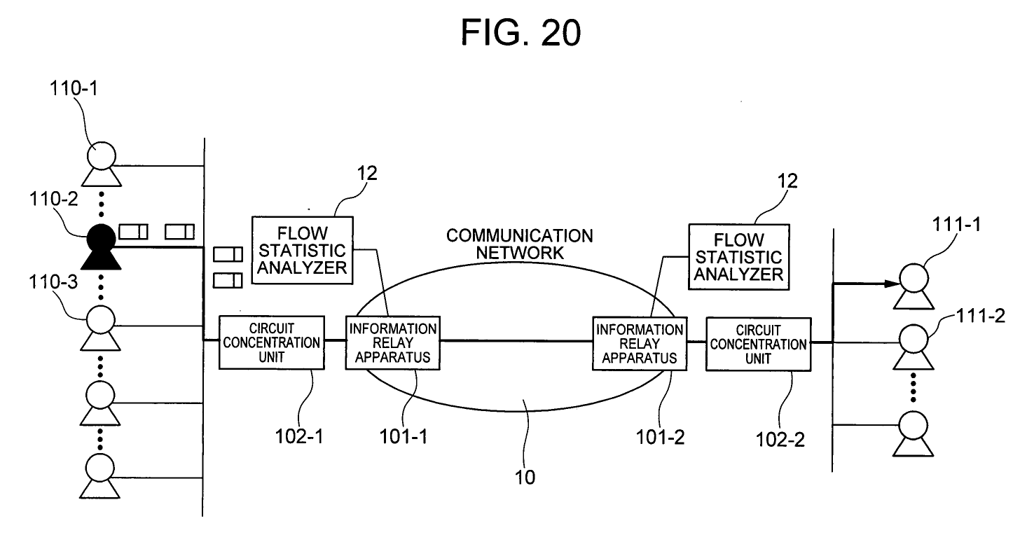

FIG. 20 is a diagram showing an example of configuration of a network to which the information relay apparatus is applied.

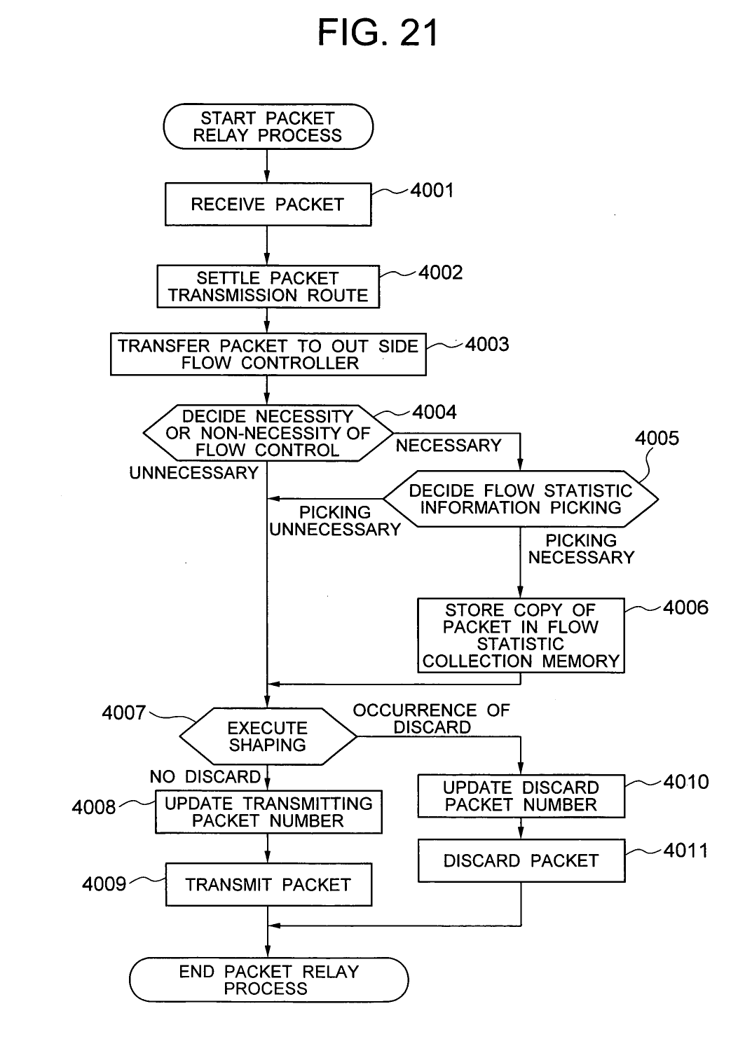

FIG. 21 is a flowchart showing an example of procedures in information relay apparatus 101-2 in FIG. 20.

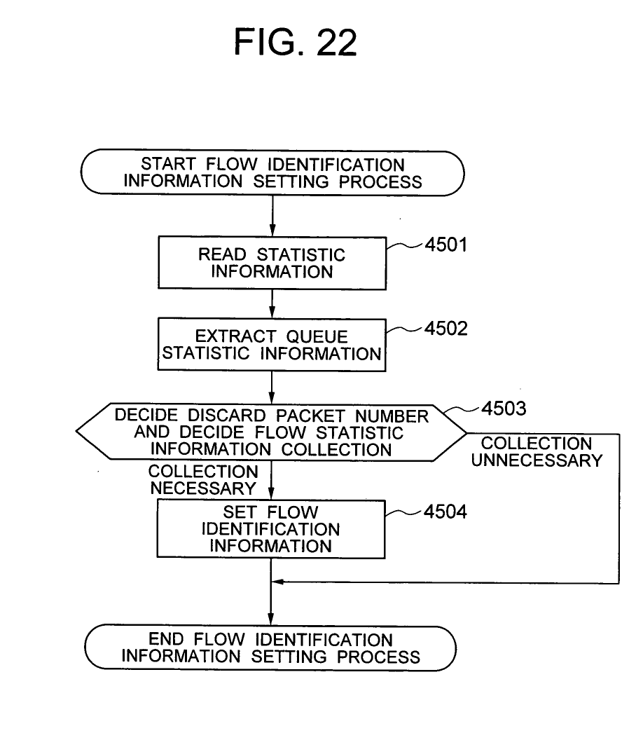

FIG. 22 is a flowchart showing another example of procedures in the information relay apparatus 101-2.

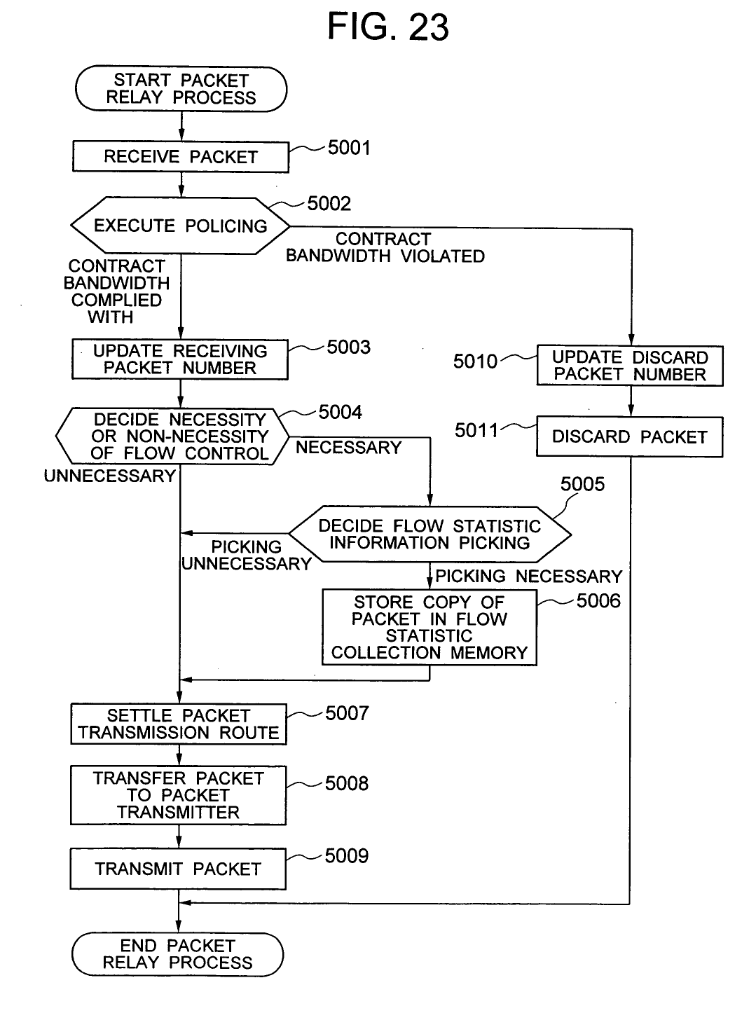

FIG. 23 is a flowchart showing an example of procedures in information relay apparatus 101-1 in FIG. 20.

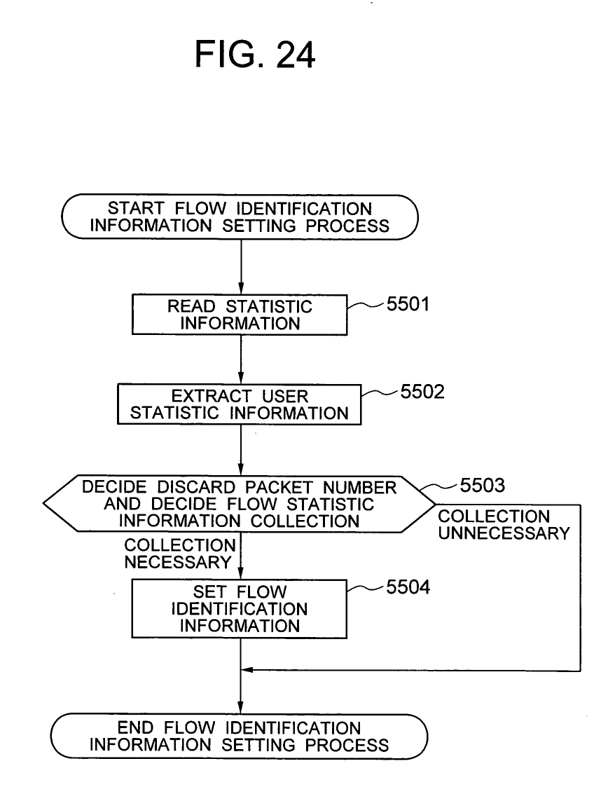

FIG. 24 is a flowchart showing another example of procedures in the information relay apparatus 101-1.

### DESCRIPTION OF THE EMBODIMENTS

The present invention will now be described by way of example with reference to the accompanying drawings.

The overall construction of an information relay apparatus to which this invention is applied is illustrated in block diagram form in FIG. 1. Details of individual components of the information relay apparatus are illustrated in FIGS. 2 through 12. In the following, the construction of the individual components constituting the information relay apparatus will first be described and then operation procedures in the individual components will be described using flowcharts.

Referring first to FIG. 1, the construction of an information relay apparatus 1 will be described.

The information relay apparatus 1 comprises an apparatus administrator 2 for controlling and managing the whole of the apparatus, a single or a plurality of packet receivers 4 connected to one or more circuits to receive packets from the connected circuits, a single or a plurality of packet transmitters 5 connected to one or more circuits to transmit packets to the connected circuits, a packet relay unit 7 for settling the next transfer destination on the basis of header information contained in a receiving packet, a switch unit 8 for relaying the packet from packet receiver 4 to packet transmitter 5, an input (IN) side flow controller 6-2 for applying flow control to the receiving packet, and an output (OUT) side flow controller 6-1 for applying flow control to a packet to be transmitted. The information relay apparatus 1 further comprises a flow statistic information transmitting module 3 which is connected to a flow statistic analyzer 12 provided externally of the apparatus, as will be described later.

Although not shown, the apparatus administrator 2 has a memory for storing software for control of the overall apparatus and various kinds of software and an execution unit (CPU) for executing the control software and the various kinds of software. The apparatus administrator 2 further includes a discard information analyzer 20 and a flow statistic transmitter 24 as will be described later. It will be appreciated that the discard information analyzer 20 and flow statistic transmitter 24 can be constructed with hardware or in the form of software to be executed by the execution unit. As shown in FIG. 1, a network administrator operation terminal 11 is connected to the apparatus administrator 2.

The packet receiver 4 includes one or more input ports connected to the one or more circuits, a reception controller 41 for complying with the kind of a circuit to be connected and receiving a packet from the connected circuit and a bandwidth monitor 42 for monitoring and controlling (policing) input bandwidths by using, for example, an LB algorithm. As will be described later, the bandwidth monitor 42 is set in advance with contract bandwidths settled user by user and on the basis of the contract bandwidths, the bandwidth monitor 42 monitors (decides) whether a receiving packet exceeds a contract bandwidth in respect of each user. Also, as will be described later, the bandwidth monitor 42 has a reception counter memory 421 and stores a count value of packets complying with a contract bandwidth (the number of receiving packets) and a count value of packets violating the contract bandwidth and being discarded (the number of discard packets).

The packet transmitter 5 includes one or more output ports connected to one or more circuits, a transmission controller 51 for complying with the kind of a circuit to be connected and transmitting a packet to the connected circuit and a bandwidth controller 52 for performing control of priority degree of packet and controlling (shaping) output bandwidths so as to transmit a packet within a contract bandwidth settled for each user. As will be described later, the bandwidth monitor 52 has transmission queues provided in respect of individual users and adapted to temporarily store packets to be transmitted. The bandwidth controller 52 is set in advance with contract bandwidths settled user by user and with transmission priority degrees settled in respect of individual application types of packets and performs control of priority degrees of packets to be transmitted in respect of individual users and controls the output bandwidth of packet in respect of each transmission queue such that it does not exceed the set contract bandwidth. Also, as will be described later, the bandwidth controller 52 has a transmission counter memory 521 to store a count value of packets to be transmitted in compliance with contract bandwidths (the number of transmitting packets) and a count value of packets violative of the contract bandwidths and to be discarded (the number of discard packets).

It is to be noted that in the foregoing description, the user does not represent each terminal and its utilizer but represents an individual, corporation, organization or group which makes a contract with, for example, a communication enterprise for the sake of utilizing a network offered by the communication enterprise to thereby transmit/receive data (packets). The user as above can be identified by, for example, a VLAN ID, source IP address, destination IP address, source MAC address or destination MAC address contained in the header of a packet.

The flow controllers 6-1 and 6-2 have flow detectors 65-1 and 65-2, respectively, and flow statistic units 66-1 and 66-2, respectively. As will be described later, the flow detectors 65-1 and 65-2 have flow control condition memories 651-1 and 651-2, respectively, each of which stores a plurality of entries each registered with information (conditions) for identifying a flow to be subjected to flow control and with contents (kinds) of flow control to be applied to packets contained in each flow. The flow statistic units 66-1 and 66-2 have flow statistic collection memories 661-1 and 661-2, respectively, each of which stores a sample gathered from a packet.

For example, as shown in FIG. 2, the packet relay unit 7 has a memory 71 stored with information (for example, routing table) for settling a transmission route (transfer destination) and a router 75. The router 75 of packet relay unit 7 receives a packet from the packet receiver 4 or IN side flow controller 6-2 and settles a transmission route (next transfer destination) of the packet on the basis of, for example, a destination IP address or destination MAC address contained in the header of the packet and route information registered in the routing table of memory 71, for instance. The router 75 transfers, together with the packet, the settled transmission route information to the switch unit 8.

The switch unit 8 receives the packet and transmission route information from the packet relay unit 7 and transfers, in accordance with the transmission route information, the packet to the packet transmitter 5 connected to a circuit to which the packet is to be transmitted or the OUT side flow controller 6-1 provided in correspondence to the packet transmitter 5.

In the information relay apparatus of FIG. 1, the packet receiver 4, packet transmitter 5, flow controller 6-1 and flow controller 6-2 are each illustrated as being one in number but as described previously, a plurality of packet receivers 4 and a plurality of packet transmitters 5 can be provided either depending on kinds of circuits connected to the information relay apparatus 1 or in respect of each connected circuit and a plurality of flow controllers 6-1 or flow controllers 6-2 can also be provided in accordance with the number of packet receivers 4 or packet transmitters 5.

Further, in the information relay apparatus 1 of FIG. 1, the packet receiver 4 and the packet transmitter 5 are illustrated as being separate constituent components but information relay apparatus 1 can be provided with one or more packet transmitter/receivers in place of the packet receiver 4 and packet transmitter 5. In this case, each of the packet transmitter/receivers can be constructed partly identically to the aforementioned packet receiver 4 and partly identically to the packet transmitter 5. Accordingly, in each packet transmitter/receiver, a portion corresponding to the packet receiver 4 receives a packet and a portion corresponding to the packet transmitter 5 transmits the packet. In this case, the switch unit 8 relays, from a packet transmitter/receiver which has received a packet, the received packet to a packet transmitter/receiver which is to transmit the packet.

Next, construction and operation of the individual components of the information relay apparatus 1 will be described in greater detail.

The packet receiver 4 is specifically constructed as illustrated in FIG. 3.

Referring to FIG. 3, the packet receiver 4 comprises one or more input ports connected to circuits, the reception controller 41 and the bandwidth monitor 42, as described previously. The bandwidth monitor 42 includes a reception packet processor 422 for temporarily holding a packet received by the reception controller 41, specifying a user of the packet and a priority degree the packet has from, for example, information contained in the header of the packet or information on an input port at which the packet is received and counting a packet length of the received packet (for example, byte number of the packet). The bandwidth monitor 42 also includes a reception packet decider 423 for calculating, in respect of each user, a cumulative amount of packets (integral value of packet lengths) which is held in the reception packet processor at the time that the packet is received and comparing a value resulting from addition of a packet length of the received packet to the cumulative amount with a cumulative amount threshold value predetermined for the specified priority degree of the packet so as to decide whether the received packet exceeds a contract bandwidth for the user. The bandwidth monitor 42 further includes a bandwidth monitor memory 424 for storing, in respect of each user, a contract bandwidth, a cumulative amount threshold value predetermined for each priority degree of packet, a sum value described as above and a packet reception time, for instance and a reception counter memory 421 for storing, in respect of a priority degree of packet of each user, a count value of packets so determined as to comply with the contract bandwidth (received packet number) and a count value of packets so determined as to violate the contract bandwidth (discarded packet number). Alternatively, putting the integral value of packet lengths aside, the reception packet decider 423 may make a decision on violation of the contract bandwidth by using a packet number or an integral value of data lengths contained in the packet.

Referring to FIG. 4, an example of information stored in the reception counter memory 421 is depicted. As shown in FIG. 4, the reception counter memory 421 stores identification information of an input port for receiving a packet (input port number allotted to each input port), identification information of a user (user ID), information indicative of a priority degree of packet (a value for identifying individual priority degrees), receiving packet number and discard packet number by making the correspondence of one information piece to others. It will be appreciated that in FIG. 4, pieces of information to be stored in the reception counter memory 421 are indicated in a table format and this table will be called herein a reception counter table. As shown in FIG. 4, the reception counter table is constructed of a plurality of entries which register values of the aforementioned input port number, user ID, priority degree identification value, receiving packet number and discard packet number, respectively. But the reception counter memory 421 need not always store the aforementioned information pieces in the table format.

Turning to FIG. 5, operation of the packet receiver 4 will be described specifically. Illustrated in FIG. 5 is a flowchart showing operation procedures in the packet receiver 4.

When the reception controller 41 of packet receiver 4 receives a packet from a circuit by way of any one of the input ports (step 1001), the received packet is sent to the reception packet processor 422 of bandwidth monitor 42. The reception packet processor 422 specifies a user of the packet from information contained in the header of the packet, for example, VLAN ID or source IP address. The reception packet processor 422 also specifies a priority degree the packet has from DSCP (Differentiated Service Code Point), source or destination IP address or source or destination port number (step 1002). Further, the reception packet processor 422 counts a packet length of the received packet. To add, the aforementioned DSCP is information to be stored in a TOS (Type of Service) field or traffic class field of the header and is set with a value of criterion for control of priority of packet in the information relay apparatus.

Subsequently, the reception packet decider 423 reads values of contract bandwidth, cumulative amount threshold value, sum value and reception time corresponding to the specified user and priority degree from the bandwidth monitor memory 424. As described previously, the read-out sum value and the reception time are a cumulative amount of packets and a time at which a packet is received at the last time, respectively. The reception packet decider 423 multiplies a time lapse between the read-out reception time and the present time by the contract bandwidth to calculate a cumulative value of packet lengths of packets delivered out of the reception packet processor during the time lapse. This value corresponds to an amount decreased from the cumulative amount of packets of the user in the reception packet processor 422. The reception packet decider 423 subtracts the calculated packet length cumulative value from the read-out sum value, thereby calculating a cumulative amount of packets of the user held in the reception packet processor 422 at present. Then, the reception packet decider 423 adds the packet length of the received packet to the calculated cumulative value and compares the sum value with the read-out cumulative amount threshold value (step 1003). If in the step 1003 the sum value is smaller than the cumulative amount threshold value, the reception packet decider 422 determines that the contract bandwidth is complied with, finds out a user ID and a priority degree identification value corresponding to the specified user and priority degree from the storage contents of the reception counter memory 421 (finds out entries in which these information pieces are registered from the reception counter table), reads and adds (+1) the receiving packet number corresponding to the information pieces and stores again the received packet number after addition in the reception counter memory 421 (step 1005). Also, the reception packet decider 422 stores in the bandwidth monitor memory 424 the present time and the calculated sum value as a reception time and a sum value corresponding to the specified user, respectively. Through this, the received packet is held in the reception packet processor 422 (step 1010).

On the other hand, if in the step 1003 the sum value is determined as exceeding the cumulative amount threshold value, the reception packet decider 423 determines that the contract bandwidth is violated, finds out a user ID and a priority degree identification value corresponding to the specified user and priority degree from the storage contents of the reception counter memory 421 (finds out entries registering these pieces of information from the reception counter table), reads and adds (+1) a discard packet number corresponding to the information pieces and stores again the discard packet number after addition in the reception counter memory 421 (step 1006). Also, the reception packet decider 423 determines whether the packet determined as violating the contract bandwidth is discarded or is transferred while decreasing its priority degree (step 1007). This decision is made to the bandwidth monitor 42 on the basis of preset information. For example, this information is set as information indicative of discard or transfer in the bandwidth monitor memory 424. In this case, the reception packet decider 423 reads this information, together with the aforementioned respective information pieces. When settling packet discard, the reception packet decider 423 discards the received packet and ends the packet reception process (step 1009). On the other hand, when settling packet transfer, the reception packet decider 423 updates, for example, the contents of the header of the packet or adds a flag indicative of a new priority degree to the packet so as to decrease the priority degree the packet has (step 1008), thus causing the reception packet processor to hold the data (step 1010).

In parallel with the above process, the reception packet processor 422 sequentially delivers the held packets of the individual users in accordance with contract bandwidths for the individual users (step 1011). The packets delivered out of the reception packet processor 422 are transferred from the packet receiver 4 to the IN side flow controller 6-2 or packet relay unit 7 shown in FIG. 1.

Referring to FIG. 6, the packet transmitter 5 is constructed specifically as illustrated therein.

In FIG. 6, the packet transmitter 5 comprises, as described previously, the transmission controller 51 connected to one or more circuits and the bandwidth controller 52 also connected to one or more circuits. The bandwidth controller 52 includes a plurality of transmission queues (transmission queues 1, 2, 3, 4) in correspondence to individual users 1 to n (n being 2 or more integer). The individual transmission queues provided for the individual users temporarily store packets having mutually different priority degrees. In order that shaping is executed by utilizing the plural transmission queues provided in respect of the individual users, the bandwidth controller 52 includes a user settling unit 522 for receiving packets from the OUT side flow controller 6-1 or switch unit 8 in FIG. 1, specifying a user of a packet from, for example, information contained in the header of the packet or transmission route information settled by the packet relay unit 7 shown in FIG. 1, deciding a priority degree the packet has and settling a transmission queue in which the packet is to be stored; and a queuing unit 523 for storing the packet in the transmission queue of the user settled by the user settling unit 522.

Also, the bandwidth controller 52 includes n user bandwidth controllers 526 for selecting any one of the transmission queues in accordance with the storage conditions of packets in the transmission queues 1 to 4 of the individual users provided in respect of the individual users and the priority degree and contract bandwidths of packets stored in each transmission queue and taking out and delivering a packet stored in the head of the selected transmission queue; and one or more circuit bandwidth controllers 525 provided for individual circuits to be connected and each adapted to select and deliver one of the packets delivered out of the individual user bandwidth controllers 526 in accordance of a bandwidth of circuit, a contract bandwidth of each user or a priority degree of packet.

Here, each transmission queue has a queue length sufficient to store packets of a predetermined amount (for example, packet length or packet number). Packets stored in the individual transmission queues are selected by the user bandwidth controller 526 or circuit bandwidth controller 525 in accordance with contract bandwidth set in connection with the individual users and transmitted from the transmission controller 51. In this manner, in the bandwidth controller 52, the output bandwidth of a packet is so controlled as to be below a contract bandwidth for a user of the packet. Accordingly, unless received packets exceed the contract bandwidth for the user, they are sequentially stored in a transmission queue provided for the user and transmitted by way of the transmission controller 51. But when packets of an amounts in excess of a contract bandwidth for a user are fed and received, the amount of packets to be stored in any transmission queue of the user exceeds an amount of packets to be taken out of the transmission queue and then transmitted. As a result, the packets cannot afford to be stored in the transmission queue and flow out of the transmission queue. Accordingly, the queuing unit 523 of bandwidth controller 52 decides the presence or absence of violation of contract bandwidth by monitoring whether packets desired to be stored in each transmission queue flow out of transmission queue.

Further, the bandwidth controller 52 includes a transmission counter memory 521 for storing a count value of packets stored in the transmission queue in respect of each transmission queue of each user (transmission packet number) and a count value of packets flown out of the transmission queue and discarded (discard packet number).

An example of information to be stored in the transmission counter memory 521 is shown in FIG. 7. As will be seen from FIG. 7, the transmission counter memory 521 stores identification information of output ports for transmitting packets (output port numbers allotted to individual output ports), identification information of users (user ID), identification information of transmission queues (transmission queue numbers allotted to individual transmission queues in respect of individual users), transmission packet number and discard packet number by making them correspondent to each other. In FIG. 7, the information pieces stored in the transmission counter memory 521 are indicated in table format and here this table will be called a transmission counter table. As shown in FIG. 7, the transmission counter table consists of a plurality of entries registering the aforementioned output port number, user ID, transmission queue number, transmission packet number and discard packet number, respectively. But the transmission counter memory 521 need not always store the aforementioned information pieces in the table format.

Next, operation of the packet transmitter 5 will be described specifically by making reference to FIG. 8. A flowchart depicted in FIG. 8 shows operation procedures in the packet transmitter 5.

When the packet transmitter 5 receives a packet from the OUT side flow controller 6-1 or switch unit 8 shown in FIG. 1, the user settling unit 522 specifies a user of the packet from information contained in the header of the packet, for example, VLAN ID, source or destination MAC address or source or destination IP address (step 1501). Further, the user settling unit 522 settles a transmission queue, in which the packet is to be stored, in accordance with the source IP address, destination IP address, source port number, destination port number, source MAC address, destination MAC address and DSCP (step 1501). It will be appreciated that in respect of a transmission queue of each user, a priority degree of a packet to be stored in the transmission queue and information for identifying a flow to which the packet belongs, for example, source IP address, destination IP address, source port number, destination port number, source MAC address, destination MAC address and DSCP which are contained in the header are set in advance in the user settling unit 522 by, for example, a network administrator. These pieces of setting information are stored in a memory, for instance, provided in the user settling unit 522 or bandwidth controller 52. Accordingly, in the step 1501, the user settling unit 522 compares individual pieces of information contained in the header of the received packet with the setting information pieces so as to settle a transmission queue in which the packet is to be stored.

Subsequently, the queuing unit 523 stores the packet received in a transmission queue settled by the user settling unit 522 from transmission queues 1 to 4 of the user specified by the user settling unit 522 (step 1502). As described previously, packets stored in the transmission queues 1 to 4 provided in respect of the individual users are sequentially taken out of the respective transmission queues in accordance with contract bandwidths and priority degrees set for the individual users and then transmitted. Accordingly, if a packet sent to the packet transmitter 5, that is, a packet about to be transmitted does not exceed the contract bandwidth of the user, the packet is stored in the transmission queue complying with its priority degree and thereafter transmitted. Bu when packets in excess of the contract bandwidth of the user are fed, the amount of packets to be stored exceeds the amount of packets taken out of each transmission queue, so that even the transmission queue complying with the priority degree of the packet cannot afford to store packets and a phenomenon that packets flow out of the transmission queue takes place (for example, a maximum storage amount of the predetermined transmission queue is exceeded). Then, in step 1502, the queuing unit 523 decides whether packets can be stored in the settled transmission queue or flow out of the transmission queue, thereby deciding whether the packet to be transmitted violates the contract bandwidth for the specified user. If in the step 1502 the packets are so determined as not to be stored in the settled transmission queue, the queuing unit 523 finds out transmission queue number and user ID corresponding to the transmission queue and specified user from the storage contents of the transmission counter memory 521 (finds out entries registering these information pieces from the transmission counter table), reads and adds by one (+1) a discard packet number being made to be correspondent to these information pieces and again stores the discard packet number after addition in the transmission counter memory 521 (step 1506). Thereafter, the queuing unit 523 discards the received packet and ends the process (step 1507). If in the step 1502 packets do not flow out of the settled transmission queue, the queuing unit 523 determines that the packet can be stored in the transmission queue, thus permitting the packet to be stored in that transmission queue.

In parallel with the aforementioned process by the user settling unit 522 and queuing unit 523, each user bandwidth controller 526 selects any one transmission queue in accordance with the presence or absence of packets stored in the transmission queues 1 to 4, respectively, their priority degrees and the contract bandwidth of the user and takes out and delivers a packet stored in the head of the selected transmission queue (step 1503). After taking out the packet from any transmission queue, each user bandwidth controller 526 finds out that transmission queue and transmission queue number and user ID corresponding to a user corresponding to the transmission queue of its own from the storage contents of the transmission counter memory 521 (finds out respective entries in the transmission counter table), reads and adds (+1) a transmission packet number correspondent to these information pieces and again stores the transmission packet number after addition to the transmission counter memory 521 (step 1504).

The circuit bandwidth controller 525 provided in correspondence to a circuit to which a packet is to be transmitted in accordance with a transmission route settled by the packet relay unit 7 shown in FIG. 1 selects one of packets delivered out of the respective user bandwidth controllers 526 in accordance with a bandwidth of the circuit and a contract bandwidth of each user or a priority degree of the packet and delivers it to the transmission controller 51. The transmission controller 51 transmits the packet delivered out of the circuit bandwidth controller 525, through the medium of an output port connected to the aforementioned circuit (step 1505).

The flow controller is constructed specifically as illustrated in FIG. 9. It is to be noted that the OUT side flow controller 6-1 and IN side flow controller 6-2 shown in FIG. 1 are constructed identically. Therefore, only the construction related to the OUT side flow controller 6-1 is depicted in FIG. 9.

In FIG. 9, the OUT side flow controller 6-1 comprises, as described previously, the flow detector 65-1 for receiving a packet transferred from the switch 8 and deciding whether the packet is contained in a flow required of flow control. The flow detector 65-1 includes a flow control condition memory 651-1 registering information (conditions) for identifying a flow for which flow control is to be executed and contents (kinds) of flow control applied to packets contained in each flow by making the correspondence therebetween, a flow comparator 652-1 for comparing the information registered in the flow control condition memory 651-1 with information contained in the header of the packet and a flow control decider 653-1 for temporarily holding the received packet, receiving a comparison result from the flow comparator 652-1 and transferring the packet by adding to it a flow control label which instructs the contents of flow control in accordance with the comparison result.

Also, the OUT side flow controller 6-1 comprises a flow statistic unit 66-1 for performing, as one of flow control operations, picking the flow statistic information (sample) from the packet. The flow statistic unit 66-1 includes a packet counter 663-1 for counting the number of packets in each flow for which collection of flow statistic information is determined to be necessary, a flow statistic picking unit 662-1 for picking a sample from the packet at predetermined sampling intervals and in accordance with a value of the packet counter 663-1 and a flow statistic collection memory 661-1 for storing the sample picked by the flow statistic picking unit 662.

The OUT side flow controller 6-1 further comprises a flow control instruction unit 67-1 for instructing the flow statistic unit 66-1 to collect flow statistic information in accordance with a flow control label added to the packet delivered out of the flow control decider 653-1 of the flow detector 65-1.

An example of information stored in the flow control condition memory 651-1 is depicted in FIG. 10. As shown in FIG. 10, the flow control condition memory 651-1 registers information for identifying the flow including source IP address, destination IP address, source MAC address, destination MAC address, source port number, destination port number, packet length (payload length), DSCP and VLAN ID as well as the contents of the flow control including information indicative of necessity/non-necessity of collection of the flow statistic information, by making the correspondence one information piece to others. As the contents of each information piece registered in the flow control condition memory 651-1, a specified value (address or port number) or information indicative of acceptance of any value (“ANY” in FIG. 10) is registered. It is to be noted that in FIG. 10 the information stored in the flow control condition memory 65-1 is indicated in table format and a plurality of entries registered with the aforementioned individual pieces of information are stored in the flow control condition memory 651-1. But the flow control condition memory 651-1 need not always hold the aforementioned individual pieces of information in table format.

In FIG. 9, only the flow statistic unit 66-1 for collecting flow statistic information for flow control is illustrated but in addition thereto, the OUT side flow controller 6-1 (and IN side flow controller 6-2) may include one or more flow control executers for executing, for example, change of priority degree of packet. In that case, the flow control condition memory 651-1 registers, as contents of flow control, processes executed by the flow control executers and information indicative of necessity or non-necessity of the execution and the flow control instruction unit 67-1 instructs any flow statistic units 66-1 or any flow control executer to execute the flow control in accordance with the flow control label. This applies to the IN side flow controller 6-2 similarly.

Next, operation of the OUT side flow controller 6-1 will be described specifically with reference to FIG. 11. Depicted in FIG. 11 is a flowchart of operation procedures in the OUT side flow controller 6-1.

When the OUT side flow controller 6-1 receives a packet from the switch unit 8 (in the case of IN side flow controller 6-2, from the packet receiver 4), the flow control decider 653-1 of flow detector 65-1 extracts the header contained in the received packet (step 2001) and transfers the extracted header to the flow comparator 652-1 (step 2002). The received packet is held in the flow control decider 653-1. In the step 2001, the flow control decider 653-1 may either prepare a copy of the header contained in the packet or take out the header from the packet and transfer it. The reason for transferring only the header to the flow comparator 652-1 is that load to be imposed on the flow comparator 652-1 can be mitigated. Unless the load on the flow comparator 652-1 is considered particularly, the whole of packet can be transferred from the flow control decider 653-1 to the flow comparator 652-1.

When receiving the header from the flow control decider 653-1, the flow comparator 652-1 compares individual information pieces of source IP address, destination IP address, source MAC address, destination MAC address, source port number, destination port number, packet length (payload length), DSCP and VLAN ID with pieces of information stored in the flow control condition memory 651-1 (information pieces registered in respective entries) in correspondence to the above information pieces, respectively, to determine coincidence of the former information pieces with the latter information pieces (step 2003). If in the step 2003 any information pieces registered in the flow control condition memory 651-1 are so determined as not to coincide with the individual information pieces in the header and the flow comparator 652-1 determines that the packet is not one corresponding to the flow identified by each information piece registered in the flow control condition memory 651-1, the received header is returned as it is to the flow control decider 653-1. On the other hand, when any information piece registered in the flow control condition memory 651-1 coincides with each information piece, the flow comparator 652-1 further decides necessity or non-necessity of collection of flow statistic information by consulting information indicative of the contents of flow control registered in the flow control condition memory 651-1 in correspondence to the coincident information pieces (step 2004). For example, the flow comparator 652-1 make a decision by consulting information indicative of necessity or non-necessity of collection of flow statistic information registered in the flow control condition memory 651-1 shown in FIG. 10. If in the step 2004 the flow control is so determined as to be unnecessary, the flow comparator 652-1 returns the received header as it is to the flow control decider 653-1. On the other hand, if the flow control is determined as being necessary, the flow comparator 652-1 adds information instructing the necessary flow control contents to the header and sends the header to the flow control decider 653-1 (step 2005). For example, in the step 2005, the flow comparator 652-1 adds information instructing collection of flow statistic information to the header and sends it to the flow control decider 653-1. It is to be noted that in the aforementioned steps 2002, 3004 and 3005 the flow comparator 652-1 may send only the decision result (representative of no-correspondence to the flow registered in the flow control condition memory 651-1, non-necessity of flow control or the contents of necessary flow control) to the flow control decider 653-1 in place of the header.

When receiving the header (or decision result) from the flow comparator 652-1, the flow control decider 653-1 adds a flow control label indicative of the contents of flow control to the temporarily held packet in accordance with the contents of the header (or decision result) and transfers the packet to the flow control instruction unit 67-1 (step 2006). In the step 2006, the flow control decider 653-1 adds a flow control label instructing non-necessity of flow control to the packet if, for example, the header is not added any information (the decision result indicates non-correspondence to flow or non-necessity of flow control). If the header is added with information instructing the contents of flow control, the flow control decider 653-1 adds to the packet a flow control label instructing the contents of flow control indicated by the information. For example, in the step 2006, information instructing collection of flow statistic information is added to the header, the flow control decider 653-1 sends the packet while adding to it a flow control label instructing collection of the flow statistic information. It is to be noted that the flow control decider 653-1 may add a flow control label only when flow control is needed but may transfer the packet without adding to it any flow control label when flow control is unneeded.

When receiving the packet, the flow control instruction unit 67-1 decides the contents of the flow control label added to the packet (step 2007). If in the step 2007 the contents of the flow control label instructions non-necessity of flow control or no flow control label is added, the flow control instruction unit 67-1 determines that any flow control is not necessary and transfers the packet to the packet transmitter 5 (in the case of IN side flow controller 6-2, the packet relay unit 7) while erasing a flow control label in case any flow control label is added (step 2013).

On the other hand, when in the step 2007 the contents of flow control label instructs collection of flow statistic information, the flow control instruction unit 67-1 determines that the flow control is necessary and prepares a copy of the received packet in accordance with the instruction and sends it to the flow statistic unit 66-1 (step 2008). When the flow statistic unit 66-1 receives the copy of the packet, the packet counter 663-1 adds (+1) a packet number in the flow in which the packet is contained. Then, the flow statistic picking unit 662-1 compares the predetermined sampling intervals set in the flow statistic picking unit 663-1 with the packet number in the flow counted by the packet counter 663-1 to decide whether flow statistic information is to be picking (step 2009). If in the step 2009 a value of the sampling interval coincides with the packet number, the flow statistic picking unit 662-1 determines that picking of the flow statistic information is necessary and writes a copy of the received packet in the flow statistic collection memory 661-1 as a sample and the flow statistic memory 661-1 stores the copy of the packet (step 2010). Also, in the step 2010, the flow statistic picking unit 662-1 sets the count value of packet counter 663-1 to “0”. To add, the packet counter 663-1 can be so constructed as to be able to count, for example, the value of sampling interval or a value less than the sampling interval value by “1”. Further, in the step 2008, in parallel with transmission of the copy of the packet to the flow statistic unit 66-1, the flow control instruction unit 67-1 erases the flow control label from the received packet and transfers the resulting packet to the packet transmitter 5 (in the case of the IN side flow controller 6-2, to the packet relay unit 7) (step 2013).

Further, in case the contents of the flow control label instructs executions of flow control other than the collection of the flow statistic information in the step 2007, the flow control instruction unit 67-1 also determines that flow control is necessary and sends the received packet or its copy to any flow control executer in accordance with the instruction to instruct it to execute the flow control (step 2011). The flow control executer receiving the packet or its copy executes such flow control as change of the priority degree of the packet (step 2012). Then, after the execution of the flow control or in parallel with the execution of the flow control, the packet is transferred from the flow control instruction unit 67-1 or flow control executer to the packet transmitter 5 (to the packet relay unit 7 in the case of the IN side flow controller 6-2) (step 2013).

According to the foregoing description, each of the packet receiver 4 and packet transmitter 5 in the information relay apparatus 1 decides the presence or absence of violation of a contract bandwidth for a packet and counts a receiving or transmitting packet number and a discard packet number but only one of them may decide the presence or absence of the contract bandwidth violation and count the receiving or transmitting packet number and the discard packet number. More particularly, if the information relay apparatus 1 acts as a shaper to execute only shaping, only the packet transmitter 5 decides the presence or absence of contract bandwidth violation for a packet about to be transmitted and counts the transmitting packet number and discard packet number. If the information relay apparatus 1 acts as a policer to execute only policing (or UPC), only the packet receiver 4 decides the presence or absence of contract bandwidth violation for a received packet and counts the receiving packet number and discard packet number.

Further, according to the foregoing description, each of the IN side flow controller 6-2 and OUT side flow controller 6-1 in the information relay apparatus 1 decides the necessity or non-necessity of flow control and picks a sample from a packet but only one of them may perform these processes. For example, if the information relay apparatus 1 acts as a shaper to execute shaping, only the OUT side flow controller 6-1 executes the above processes. But if the information relay apparatus 1 acts as a policer to execute policing (or UPC), only the IN side flow controller 6-2 executes the aforementioned processes.

In this manner, the information relay apparatus 1 is so constructed as to be able to execute either shaping or policing.

Next, the apparatus administrator 2 will be described in greater detail. When an executer, not shown, executes control software and a variety of other kinds of software stored in a memory, not shown, the apparatus administrator 2 carries out control of the whole of the information relay apparatus such as management of setting information inputted by a network administrator from the network administrator operation terminal 11, management of inputted setting information or management of the apparatus status. The apparatus administrator 2 includes the discard information analyzer 20 and the flow statistic transmitter 24. The discard information analyzer 20 analyzes the discard packet number, receiving packet number or transmitting packet number settled by means of the bandwidth monitor 42 of packet receiver 4 and the bandwidth controller 52 of packet transmitter 5 and in accordance with the analytical results, automatically sets identification information of a flow subject to flow control in the OUT side flow controller 6-1 and IN side flow controller 6-2. The flow statistic transmitter 24 transmits, to the flow statistic analyzer 12, flow statistic information picked by the flow statistic unit 66-1 of OUT side flow controller 6-1 or the flow statistic unit 66-2 of IN side flow controller 6-2.

The discard information analyzer 20 is constructed specifically as illustrated in FIG. 12.

In FIG. 12, the discard information analyzer 20 comprises an information collector 21 and a flow decider 22. The information collector 21 acquires statistic information such as transmitting packet number and discard packet number counted by the bandwidth monitor 42 of packet receiver 4 or the bandwidth controller 52 of packet transmitter 5 and stored in the reception counter memory 421 or transmission counter memory 521. The flow decider 22 includes a discard flow deciding unit 225 for deciding whether flow statistic information is picked in respect of a flow in which packet discard occurs and a flow control information operation unit 226 for automatically setting, when the discard flow deciding unit 225 determines that the flow statistic information is to be picked, information for identifying a flow of interest in the flow control condition memory 651-1 of OUT side flow controller 6-1 or the flow control condition memory 651-2 of IN side flow controller 6-2, for the purpose of causing them to execute flow control in respect of the flow. The flow decider 22 further includes a flow detection memory 221. The flow detection memory 221 stores pieces of information set in advance by the network administrator through the use of the network administrator operation terminal 11, for example, information for identifying the flow to which the packet belongs and threshold information for deciding normality or abnormality of the discard packet number, by making these pieces of information correspondent to each other.

An example of information pieces stored in the flow detection memory 221 is depicted in FIG. 13. Specifically exemplified in FIG. 13 are information pieces used in order for the bandwidth controller 52 of packet transmitter 5 to decide whether flow statistic information is picked or not in respect of a flow in which packet discard occurs and in order for the flow control condition memory 651-1 of OUT side flow controller 6-1 to identify the flow. An example of information used for the bandwidth monitor 42 of packet receiver 4 to pick flow statistic information in respect of a flow in which packet discard occurs will be described later but it is possible to use the same information for the both cases.

In FIG. 13, the flow detection memory 221 stores not only values of output port number, user ID, transmission queue number, source IP address, destination IP address, source MAC address, destination MAC address, source port number and destination port number and DSCP but also transmitting packet number and discard packet number counted by the bandwidth controller 52, threshold value for deciding normality or abnormality of the discard packet number and decision flag for deciding whether collection of flow statistic information is necessary when the discard packet number exceeds the threshold value, by making these information pieces correspondent to each other. The threshold value shown in the example of FIG. 13 indicates a ratio of the discard packet number to the transmitting packet number. The threshold value referred to herein may be, for example, a maximum value of discard packet number determined as being normal. It is to be noted that the information pieces stored in the flow detection memory 221 are indicated in table format and the table for flow retrieval consists of a plurality of entries registered with the individual values described as above. But the flow detection memory 221 need not always store the aforementioned information pieces in table format.

Turning now to FIG. 14, operation of the discard information analyzer 20 will be described specifically. Illustrated in FIG. 14 is a flowchart showing operation procedures in the discard information analyzer 20 provided with the flow detection memory 221 storing the information shown in FIG. 13.

The information collector 21 of discard information analyzer 20 reads, for example, periodically the statistic information stored in the transmission counter memory 521 of packet transmitter 5 (step 2501). The information collector 21 transfers the acquired statistic information to the discard flow deciding unit 225 of flow decider 22. The discard flow deciding unit 225 analyzes the statistic information and extracts combinations of user ID, transmission queue number, transmitting packet number and discard packet number contained in the statistic information, or groups of queue statistic information, combination by combination (step 2502). To add, one combination of user ID, transmission queue number, transmitting packet number and discard packet number extracted from the statistic information is called queue statistic information and the statistic information includes a number of pieces of queue statistic information corresponding to the transmission queues in number. The discard flow deciding unit 225 calculates a ratio of the discard packet number to the transmitting packet number in one piece of queue statistic information extracted from the statistic information. Also, the discard flow deciding unit 225 finds out of the information stored in the flow detection memory 221 a user ID and a transmission queue number which coincide with the user ID and transmission queue number in the extracted queue statistic information, reads a piece of information such as a threshold value corresponding to the user ID and transmission queue number (herein called user flow detection information) from the flow detection memory 221 and compares the calculated ratio with the read-out threshold value. In this manner, the discard flow deciding unit 225 decides whether the discard packet number in the extracted queue statistic information is normal or abnormal (step 2503). If in the step 2505 the calculated ratio value exceeds the read-out threshold value, the discard flow deciding unit 225 determines that the discard packet number is abnormal and decides from a decision flag in the read-out user flow detection information whether collection of the flow statistic information is necessary or unnecessary (step 2504). When the decision flag indicates that the collection of the flow statistic information is necessary, the discard flow deciding unit 225 transfers, as information for identifying the flow in the read-out user flow detection information, values of source IP address, destination IP address, source port number, destination port number, source MAC address, destination MAC address and DSCP to the flow control information operation unit 226 (step 2505). The above information pieces are correspondent to user ID and transmission queue number which coincide with the user ID and transmission queue number in the queue statistic information.

The flow control information operation unit 226 registers the flow identification information and the information indicative of the necessity of collection of the flow statistic information in the flow control condition memory 651-1 of OUT side flow controller 6-1 by making them correspondent to each other (step 2506). Through this, the flow control condition memory 651-1 is newly added with the information pieces for identifying the flow and thereafter, the flow comparator 652-1 and flow control decider 653-1 in the OUT side flow controller 6-1 detect the packet having the contents of header coincident with the newly added information pieces as a packet for which flow control is necessary.

The discard flow deciding unit 225, on the other hand, replaces (updates) the values of the transmitting packet number and discard packet number in the user flow detection information read out of the flow detection memory 221 with the values of the transmitting packet number and discard packet number in the queue statistic information and again stores the user flow detection information in the flow detection memory 221 (step 2507).

When on the other hand the calculated ratio value is less than the read-out threshold value in the step 2503, the discard flow deciding unit 225 determines that the discard packet number is normal and executes the aforementioned step 2507. Even when the decision flag indicates that the collection of flow statistic information is unnecessary, the discard flow decider 225 also executes the aforementioned step 2507.

The discard flow deciding unit 225 repeats the aforementioned procedures in respect of a plurality of queue statistic information pieces extracted from the statistic information (step 2508) and ends the process.

Next, another example of the information stored in the flow detection memory 221 will be described with reference to FIG. 15. Specifically depicted in FIG. 15 is an example of information used in order for the bandwidth monitor 42 of packet receiver 4 to decide whether flow statistic information is picked in respect of a flow in which packet discard occurs and to set information necessary for identifying the flow in the flow control condition memory 651-2 of IN side flow controller 6-2.

In FIG. 15, the flow detection memory 221 stores not only values of input port number, user ID, source IP address, VLAN ID and priority degree identification value but also transmitting packet number and discard packet number which are counted by the bandwidth monitor 42, threshold value for deciding whether the discard packet number is normal or abnormal and decision flag for deciding whether collection of flow statistic information is necessary or not when the discard packet number exceeds the threshold value, by making them correspondent to each other. The threshold value shown in the example of FIG. 15 indicates a ratio of the discard packet number to the transmitting packet number as in the case of FIG. 13. In FIG. 15, the information pieces stored in the flow detection memory 221 are indicated in table format and this table for flow retrieval consists of a plurality of entries registered with the respective values as above.

Next, operation of the discard information analyzer 20 provided with the flow detection memory 221 storing the information shown in FIG. 15 will be described by making reference to a flowchart of FIG. 16.

The information collector 21 of discard information analyzer 20 reads, for example, periodically the statistic information stored in the reception counter memory 421 of packet receiver 4 (step 3001). The information collector 21 transfers the acquired statistic information to the discard flow deciding unit 225 of flow decider 22. The discard flow deciding unit 225 analyzes the statistic information and extracts combinations of user ID, priority degree identification value, transmitting packet number and discard packet number which are contained in the statistic information combination by combination (step 3002). One combination of user ID, priority degree identification value, transmitting packet number and discard packet number which are extracted from the statistic information is herein called user statistic information and the statistic information includes a plurality of pieces of user statistic information. The discard flow deciding unit 225 calculates a ratio of the discard packet number to the transmitting packet number in one piece of user statistic information extracted from the statistic information. Also, the discard flow deciding unit 225 finds out user ID and priority degree identification value which coincide with the user ID and priority degree identification value in the extracted user statistic information from the information stored in the flow detection memory 221, reads each piece of information such as a threshold value correspondent to the user ID and priority degree identification value (called user flow detection information) from the flow detection memory 221 and compares the calculated ratio value with the read-out threshold value. Through this, the discard flow deciding unit 225 decides whether the discard packet number in the extracted user statistic information is normal or not (step 3003). If in the step 3003 the calculated ratio value exceeds the read-out threshold value, the discard flow deciding unit 225 determines that the discard packet number is abnormal and decides, from a decision flag in the read-out user flow detection information, whether collection of flow statistic information is necessary or not (step 3004). In case the decision flag indicates that the collection of the flow statistic information is necessary, the discard flow deciding unit 225 transfers, as information necessary for identifying the flow in the read-out user flow detection information, respective values of source IP address and VLAN ID to the flow control information operation unit 226 (step 3005).

The flow control information operation unit 226 registers the flow identification information and the information indicative of necessity of collection of the flow statistic information in the flow control condition memory 651-2 of IN side flow controller 6-2 by making them correspondent to each other (step 3006). In this manner, the flow control condition memory 651-2 is newly added with information pieces for identifying the flow and thereafter the flow comparator 652-2 and flow control decider 653-2 of IN side flow controller 6-2 detect, as a packet for which flow control is necessary, a packet for which the newly added information pieces coincide with the contents of the header.

Also, the discard flow deciding unit 225 replaces (updates) values of the transmitting packet number and discard packet number in the user flow detection information read out of the flow detection memory 221 with the values of the transmitting packet number and discard packet number in the user statistic information and again stores the user flow detection information in the flow detection memory 221 (step 3007).

On the other hand, in case the calculated ratio value is below the read-out threshold value in the step 3003, the discard flow deciding unit 225 determines that the discard packet number is normal and executes the aforementioned step 3007. If in the step 3004 the deciding flag indicates that the collection of flow statistic information is unnecessary, the discard flow deciding unit 225 also executes the aforementioned step 3007.

The discard flow deciding unit 225 repeats the aforementioned procedures in respect of a plurality of pieces of user statistic information extracted from the statistic information (step 3008) and ends the process.

Turning now to FIG. 17, another example of the information stored in the flow detection memory 221 will be described. The information pieces shown in FIGS. 13 and 15 are used to decide whether flow statistic information is to be picked in respect of a flow in which packet discard occurs and to set information for identifying the flow in the flow control condition memory 651-1 and flow control condition memory 651-2. Incidentally, the OUT side flow controller 6-1 and IN side flow controller 6-2 can also execute flow control other than the collection of flow statistic information as described previously. Then, depicted in FIG. 17 is an example of information used to set, in addition to the information for identifying the flow, the contents of flow control in the flow control condition memory 651-1 and flow control condition memory 651-2. Specifically, in FIG. 17, an example of information used to set information in the flow control condition memory 651-1 but a similar example can be provided for information used to set information in the flow control condition memory 651-2.

In FIG. 17, the flow detection memory 221 stores information pieces substantially similar to those shown in FIG. 13 by making them correspondent to each other. The information shown in FIG. 17 differs from the information shown in FIG. 13 in that action information substituting for the decision flag in FIG. 13 is included. The action information indicates the contents of flow control to be executed by the OUT side flow controller 6-1 when the discard packet number exceeds the threshold value. Enumerated as the contents of action information are, for example, discarding all packets contained in a flow, informing the network administrator of alarm (displaying alarm on the network administrator operation terminal 11) and informing the apparatus disposed upstream in the communication network 10 of an abnormal flow.

When using the information shown in FIG. 17, the discard flow deciding unit 225 of discard information analyzer 20 decides, from action information in the user flow detection information read out, for example, in the step 2504 shown in FIG. 14, what flow control is necessary and if any flow control is needed, it transfers the information for identification of flow contained in the user flow detection information and the action information to the flow control information operation unit 226. The flow control information operation unit 226 registers the received information pieces in the flow control condition memory 651-1 by making them correspondent to each other. Through this, the flow comparator 652-1 and flow control decider 653-1 of OUT side flow controller 6-1 detect, as a packet for which flow control designated by the action information is necessary, a packet having the header whose contents coincides with the newly added information pieces and the flow control executer also executes the designated flow control. The above can similarly be applied to the case of registration in the flow control condition memory 651-2.

Next, how the flow statistic transmitter 24 of apparatus administrator 2 transmits flow statistic information picked in, for example, the flow statistic unit 66-1 of OUT side flow controller 6-1 to the flow statistic analyzer 12 will be described specifically by making reference to FIG. 18. Illustrated in FIG. 18 is a flowchart useful to explain operation procedures in the flow statistic transmitter 24.

When the flow statistic information pieces (sample) are cumulated in the flow statistic collection memory 661-1 by a predetermined amount, the flow statistic information stored in the flow statistic collection memory 661-1 is sent therefrom to the flow statistic transmitter 24. The flow statistic transmitter 24 receives the flow statistic information from the flow statistic unit 66-1 (step 3501). With the aim of transmitting the flow statistic information to the flow statistic analyzer 12, the flow statistic transmitter 24 prepares a flow statistic information transmission frame (step 3502). This transmission frame is settled in advance pursuant to specifications of the flow statistic function. For example, in case the sFlow technology described in RFC 3176 is adopted, the flow statistic transmitter 24 prepares a transmission frame pursuant to a transmission frame format shown in FIG. 19. According to the sFlow technology, flow samples of transfer packets and a counter sample representing a transfer packet number are picked and therefore, the transmission frame consists of an sFlow header settled by the sFlow technology, a plurality of flow samples and a counter sample, as shown in FIG. 19. The flow statistic information transmission frame prepared by the flow statistic transmitter 24 is delivered out of the flow statistic transmitter 24 to the flow statistic information transmission module 3 and is transmitted therefrom to the flow statistic analyzer 12 (step 3503).

With the flow statistic information transmission frame transmitted from the flow statistic transmitter 24 in this manner, the flow statistic analyzer 12 receives the flow statistic information transmission frame. The flow statistic analyzer 12 executes software for analysis of the flow statistic information to analyze the flow statistic information contained in the flow statistic information transmission frame. This enables the flow statistic analyzer 12 (the network administrator utilizing the flow statistic analyzer 12) to analyze the flow relayed by the information relay apparatus 1 which has transmitted the flow statistic information transmission frame and to specify an abnormal flow taken advantage of by a DoS attack or DDoS attack.

Subsequently, an example will be described in which the aforementioned information relay apparatus 1 is applied to a communication network provided by a communication enterprise.

Referring to FIG. 20, there is illustrated an example of configuration of a network. In FIG. 20, information relay apparatuses 101-1 and 101-2 are arranged at sites corresponding to inlet and outlet, respectively, of a communication network 10. Each of the information relay apparatuses 101-1 and 101-2 is constructed identically to the previously-described information relay apparatus 1, having the individual components as shown in FIG. 1. The information relay apparatus 101-1 is connected with a circuit concentration unit 102-1. The circuit concentration unit 102-1 is connected to a plurality of users 110-1 to 110-n via a plurality of circuits. Similarly, the information relay apparatus 101-2 is connected with a circuit concentration unit 102-2. The circuit concentration unit 102-2 is connected to a plurality of users 111-1 to 111-n via a plurality of circuits. The circuit concentration units 102-1 and 102-2 each multiplex packets sent from each user through each circuit and send them to the information relay apparatuses 101-1 and 101-2, respectively, through a high-speed communication circuit. Also, each of the circuit concentration units 102-1 and 102-2 distributes received packets to any of circuits in accordance with their destination.

It is now presupposed that in FIG. 20 a user 110-2 connected to the circuit concentration unit 102-1 transmits data (packet) to a user 111-1 connected to the circuit concentration unit 102-2 via the communication network 10 and the previously-described information relay apparatus 1 is arranged as the information relay apparatus 101-2. Such a case will be described. In this case, the information relay apparatus 101-2 executes the previously-described shaping in respect of packets received from the communication network 10 and relayed to the individual users 111-1 to 111-n and transmits the packets in accordance with contract bandwidths made with the individual users 111-1 to 111-n. Also, the information relay apparatus 101-2 decides necessity or non-necessity of flow control in connection with the packets about to be transmitted to the individual users 111-1 to 111-n and executes the flow control. On the other hand, the information relay apparatus 101-2 need not perform policing and flow control in respect of packets received from the communication network 10. Accordingly, in the following description, it is assumed that the information relay apparatus 101-2 executes neither policing based on the bandwidth monitor 42 shown in FIG. 1 nor flow control based on the IN side flow controller 6-2.

Operation of the information relay apparatus 101-2 will now be described specifically by using flowcharts shown in FIGS. 21 and 22.

Referring first to FIG. 21, the reception controller 41 of any packet receiver 4 in the information relay apparatus 101-2 receives, via an input port, a packet transferred from the communication network 10 (step 4001). The reception controller 41 transfers the received packet to the packet relay unit 7.

The router 75 of packet relay unit 7 settles a transmission route (next transfer destination) on the basis of information contained in the header of the packet and information registered in the routing table (step 4002) and transfers the packet and the transmission route information to the switch unit 8.

In accordance with the transmission route information received from the packet relay unit 7, the switch unit 8 transfers the packet to the OUT side flow controller 6-1 provided in correspondence to the packet transmitter 5 connected to a circuit to which the packet is to be transmitted (step 4003).

When receiving the packet from the switch unit 8, the flow detector 65-1 of OUT side flow controller 6-1 decides necessity or non-necessity of flow control for the received packet as has be explained in connection with FIG. 11 (step 4004). More particularly, the flow detector 65-1 determines the necessity or non-necessity of flow control by executing the steps 2001 to 2006 shown in FIG. 11 and transfers the packet to the flow control instruction unit 67-1 by adding or not adding a flow control label. When the flow control is determined to be necessary, the flow control instruction unit 67-1 follows an instruction in the flow control label and sends a copy of the packet, for instance, to the flow statistic unit 66-1. Regardless of the fact that the necessity of flow control is determined or the non-necessity thereof is determined, the flow control instruction unit 67-1 transfers the packet to the packet transmitter 5.

When receiving the copy of the packet from the flow control instruction unit 67-1, the flow statistic picking unit 662-1 of flow statistic unit 66-1 compares predetermined sampling intervals with a packet number in the flow counted by the packet counter 663-1 to decide whether flow statistic information is to be picked (step 4005). If the value of sampling intervals equals the packet number, the flow statistic picking unit 662-1 stores, as a sample, the received packet copy in the flow statistic collection memory 661-1 (step 4006). It is to be noted that the flow control instruction unit 67-1 may transfer the packet to another flow control executer in accordance with a flow control label. In this case, flow control other than the collection of flow statistic information is executed in the steps 4005 and 4006.

When receiving the packet from the OUT side flow controller 6-1, the bandwidth controller 52 of packet transmitter 5 executes shaping as explained in connection with FIG. 8 (step 4007). More particularly, the bandwidth controller 52 executes the steps 1501 and 1502 shown in FIG. 8 to specify a user of the packet (here user 111-1), settle a transmission queue and store the packet in the settled transmission queue. In case the packet flows out of the transmission queue, failing to be stored therein in the step 4007, the bandwidth controller 52 executes the step 1506 shown in FIG. 8 to update a discard packet number corresponding to specified user and transmission queue and stored in the transmission counter memory 521 (step 4010) and to discard the packet (step 4011).

Also, the bandwidth controller 52 executes the steps 1503 and 1504 shown in FIG. 8 to take out a packet stored in any transmission queue in respect of each user and update a transmission packet number corresponding to specified user and transmission queue stored in the transmission counter memory 521 (step 4008). Then, the bandwidth controller 52 sequentially sends packets taken out of the transmission queues in respect of the individual users to the transmission controller 51 which in turn transmits the received packets to the connected circuits (step 4009).

Turning now to FIG. 22, the information collector 21 of discard information analyzer 20 in the apparatus administrator 2 reads, for example, periodically as explained in connection with FIG. 14, statistic information stored in the transmission counter memory 521 of packet transmitter 5 (step 4501). The information collector 21 transfers the read-out statistic information to the flow decider 22 and then the flow decider 22 extracts combinations of queue statistic information pieces contained in the statistic information combination by combination (step 4502). The flow decider 22 executes the steps 2503 and 2504 shown in FIG. 14 to decide whether the discard packet number in the extracted queue statistic information is normal or abnormal and if abnormality is determined, decides whether collection of the flow statistic information is necessary or not (step 4503). In case the collection of flow statistic information is determined to be necessary, the flow decider 22 executes the steps 2405 and 2506 shown in FIG. 14 to register information for identifying the flow in the flow control condition memory 651-1 of OUT side flow controller 6-1 (step 4504). Thereafter, the flow decider 22 executes the step 2507 shown in FIG. 14 to update the contents of the flow detection memory 221 and end the process. Also, even if the collection of flow statistic information is determined to be unnecessary in step 4503, the contents of the flow detection memory 221 is updated and the process is ended.

Through the steps as described above, relay of the packet by the information relay apparatus 101-2 ends.

For example, in the case of DoS attack and DDoS attack, packets in excess of the contract bandwidth are transmitted to an arbitrary destination and as a result, packets flow out of a transmission queue corresponding to the destination and there occurs packet discard. As described previously, when a large number of packets belonging to a specified flow are discarded in the packet transmitter 5, the discard information analyzer 20 of apparatus administrator 2 determines that the discard packet number counted by the packet transmitter 5 is abnormal and sets information for identifying the flow to which the discarded packets belong in the flow control condition memory 651-2 of OUT side flow controller 6-1. Consequently, the flow statistic unit 66-1 of OUT side flow controller 6-1 picks flow statistic information from a packet belonging to the same flow to which the packets discarded by a great number belong. In this manner, by monitoring the discard packet number transmission queue by transmission queue, occurrence of congestion can be detected and besides, a flow dubious about its abnormality can be specified. Therefore, the number of flows to be analyzed by the flow statistic analyzer 12 (flows dubious about their abnormality) can be narrowed down to, for example, 1/(user number xtransmission queue number for each user) as compared to the total flow number.

Next, an instance will be described which presupposes, as in the foregoing, that the user 110-2 connected to the circuit concentration unit 102-1 transmits data (packet) to the user 111-1 connected to the circuit concentration unit 102-2 via the communication network 10 and the aforementioned information relay apparatus 1 is arranged in the communication network to act as the information relay apparatus 101-1. In this case, the information relay apparatus 101-1 executes the aforementioned policing in respect of packets received from the circuit concentration unit 102-1 and receives the packets in accordance with contract bandwidths made with the individual users 110-1 to 110-n. Also, the information relay apparatus 101-1 decides the necessity or non-necessity of flow control in respect of packets received from the individual users 110-1 to 110-n and executes the flow control. On the other hand, the information relay apparatus 101-1 need not perform shaping and flow control for a packet the apparatus 101-1 is about to transmit to the communication network 10. Therefore, in the following description, it is assumed that the information relay apparatus 101-1 executes neither shaping based on the bandwidth controller 52 shown in FIG. 1 nor flow control based on the OUT side flow controller 6-1.

Operation of the information relay apparatus 101-1 will now be described specifically by using flowcharts shown in FIGS. 23 and 24.

Referring first to FIG. 23, the reception controller 41 of any packet receiver 4 in the information relay apparatus 101-1 receives a packet, fed via a circuit and an input port, from the circuit concentration unit 102-1 (step 5001). When the reception controller 41 receives the packet, the bandwidth monitor 42 of packet receiver 4 executes policing as explained in connection with FIG. 5 (step 5002). More particularly, the bandwidth monitor 42 executes the steps 1002 and 1003 shown in FIG. 5 to specify user (here user 110-2) and priority degree of the packet, calculate a cumulative amount of packets of the specified user, add a packet length of the packet to the cumulative amount and compare the sum value with a cumulative amount threshold value corresponding to the specified priority degree. If in the step 5002 the sum value is below the cumulative amount threshold value, the bandwidth monitor 42 executes the step 1005 shown in FIG. 5 to update a receiving packet number corresponding to the specified user and priority degree and stored in the reception counter memory 421 (step 5003). Then, the band monitor 42 executes the steps 1010 and 1011 shown in FIG. 5 to temporarily hold the received packet and transfer held packets of each user to the IN side flow controller 6-2 in accordance with the contract bandwidth.

On the other hand, if in the step 5002 the sum value exceeds the cumulative amount threshold value, the bandwidth monitor 42 executes the step 1006 shown in FIG. 5 to update the discard packet number corresponding to the specified user and priority degree and stored in the reception counter memory 421 (step 5010). The bandwidth monitor 42 also executes the step 1007 shown in FIG. 5 to decide whether the packet is to be discarded and in accordance with the determination, discards the packet (step 5011) and ends the packet reception process.

When receiving the packet from the packet receiver 4, the flow detector 65-2 of IN side flow controller 6-2 decides, as described in connection with FIG. 11, the necessity or non-necessity of flow control for the received packet (step 5004). More particularly, the flow detector 65-2 executes the steps 2001 to 2006 shown in FIG. 11 to decide the necessity or non-necessity of flow control and transfers the packet to the flow control instruction unit 67-2 while adding or not adding a flow control label to the packet. When the flow control is determined to be necessary, the flow control instruction unit 67-2 follows an instruction by the flow control label to send, for example, a copy of the packet to the flow statistic unit 66-2. Regardless of the fact that the flow control is determined to be necessary or unnecessary, the flow control instruction unit 67-2 transfers the packet to the packet relay unit 7.

When receiving the copy of the packet from the flow control instruction unit 67-2, the flow statistic picking unit 662-2 of flow statistic unit 66-2 compares a predetermined sampling intervals with the packet number in the flow counted by the packet counter 663-2 and decide whether flow statistic information is to be picked (step 5005). If the sampling interval value equals the packet number, the flow statistic picking unit 662-2 stores, as a sample, the received copy of the packet in the flow statistic collection memory 661-2 (step 5006). It is to be noted that the flow control instruction unit 67-2 may follow the flow control label to transfer the packet to another flow control executer.

In this case, flow control other than the collection of flow statistic information is executed in the steps 5005 and 5006.

When receiving the packet from the IN side flow controller 6-2, the router 75 of packet relay unit 7 settles a transmission route of the packet (next transfer destination) on the basis of information contained in the header of the packet and information registered in the routing table (step 5007) and transfers the packet and transmission route information to the switch unit 8.

Following the transmission route information received from the packet relay unit 7, the switch unit 8 transfers the packet to the packet transmitter 5 connected to a circuit to which the packet is to be transmitted (step 5008).

When receiving the packet from the switch unit 8, the transmission controller 51 of packet transmitter 5 transmits the received packet to the communication network 10 through an output port (step 5009).

Turning now to FIG. 24, the information collector 21 of discard information analyzer 20 in the apparatus administrator 2 reads, for example, periodically the statistic information stored in the reception counter memory 421 of packet receiver 4 as has been explained in connection with FIG. 16 (step 5501). The information collector 21 transfers the read-out statistic information to the flow decider 22 which in turn extracts combinations of user statistic information pieces contained in the statistic information combination by combination (step 5502). The flow decider 22 executes the steps 3003 and 3004 shown in FIG. 16 to decide whether the discard number in the extracted user statistic information is normal or abnormal and decide whether collection of the flow statistic information is necessary or unnecessary if the abnormality is determined (step 5503). In case the collection of flow statistic information is necessary, the flow decider 22 executes the steps 3005 and 3006 shown in FIG. 16 to set information necessary for identifying the flow in the flow control condition memory 651-2 of IN side flow controller 6-2 (step 5504). Thereafter, the flow decider 22 executes the step 3007 shown in FIG. 16 to update the contents of the flow detection memory 221 and end the process. Even when the collection of flow statistic information is determined to be unnecessary in the step 5503, the flow decider 22 ends the process after updating the contents of the flow detection memory 221.

Through the procedures as above, relay of the packet by the information relay apparatus 101-1 ends.

As described previously, in the event that packets in excess of the contract bandwidth as in the case of DoS attack, for instance, are transmitted from an arbitrary source to an arbitrary destination, the packet discard also occurs in the packet receiver 4. As described previously, when a great number of packets belonging to a specified flow are discarded in the packet receiver 4, the discard information analyzer 20 of apparatus administrator 2 determines that the discard packet number counted by the packet receiver 4 is abnormal and sets information for identifying the flow to which the discarded packets belong in the flow control condition memory 651-2 of IN side flow controller 6-2. As a result, the flow statistic unit 66-2 of IN side flow controller 6-2 picks flow statistic information from packets belonging to the same flow to which the packets discarded by a great number in the packet receiver 4 belong. In this manner, by monitoring the discard packet number in the packet receiver 4, occurrence of congestion can also be detected and besides a flow dubious of an abnormal flow can be specified. Therefore, the number of flows to be analyzed by the flow statistic analyzer 12 (dubiously abnormal flows) can be narrowed down to, for example, 1/(user number xpriority degree) as compared to the total flow number.

As has been described, when a great number of packets belonging to a specified flow are discarded in the packet transmitter 5 or packet receiver 4, the discard information analyzer 20 of apparatus administrator 2 determines that the discard packet number counted by the packet transmitter 5 or packet receiver 4 is abnormal and sets information for identifying a flow to which the discarded packets belong in the flow control condition memory 651-1 of OUT side flow controller 6-1 or the flow control condition memory 651-2 of IN side flow controller 6-2. As a result, the flow statistic unit 66-1 of OUT side flow controller 6-1 or the flow statistic unit 66-2 of IN side flow controller 6-2 picks statistic information from packets belonging to the same flow to which the packets discarded by a great deal in the packet transmitter 5 or packet receiver 4 belong, that is, the flow dubious of an abnormal flow. In this manner, the object from which the flow statistic information is collected can be restricted to one of all flows to be relayed which is dubious about an abnormal flow. Through this, the flow statistic analyzer 12 can receive flow statistic information concerning an abnormal flow from the information relay apparatus, thereby ensuring that the number of analytical object flows for which the flow statistic analyzer 12 intends to perform detection of abnormal flow can be decreased, the analysis work can be reduced to a great extent and an abnormal flow can be specified at a higher speed. Further, when the information relay apparatus 1 performs setting of, for example, discarding all abnormal flows, informing the apparatus administrator of alarm and giving information to the apparatus upstream in the communication network 10, countermeasures against abnormal flows can be taken more rapidly.

It should be further understood by those skilled in the art that although the foregoing description has been made on embodiments of the invention, the invention is not limited thereto and various changes and modifications may be made without departing from the spirit of the invention and the scope of the appended claims.

1. An information relay apparatus connected to a plurality of circuits to relay packets, comprising:
a packet receiver/transmitter which receives/transmits packets;
a relay unit which settles a transfer destination of a packet;
a bandwidth controller which execute policing or shaping in respect of receiving or transmitting packets and counting the number of packets so determined as to violate contract bandwidths made with individual users;
a flow controller which detects, from receiving or transmitting packets, packets each having, in its header, information which coincides with flow identification information registered in advance and collecting flow statistic information; and
an analyzer which registers information for identifying a flow to which the packets belong in the flow controller when the number of packets counted by the bandwidth controller exceeds a predetermined threshold value.

2. The information relay apparatus according to claim 1, wherein the analyzer periodically acquires the number of packets counted by the bandwidth controller and compares it with the threshold value.

3. The information relay apparatus according to claim 1, wherein the analyzer comprises a flow detection memory which stores at least user identification information, flow identification information and the threshold value by making them correspondent to each other, and wherein the flow identification information correspondent to the user identification information coincident with identification information of users of the packets acquired, together with the packet number, from the bandwidth controller and the threshold value are read out of the flow detection memory and when the number of packets exceeds the threshold value, the read-out flow identification information is registered in the bandwidth controller.

4. The information relay apparatus according to claim 1, wherein the flow controller comprises a flow condition memory in which the flow identification information is registered by means of the analyzer and wherein packets belonging to the flow in which the number of packets so determined as to violate the contract bandwidths by means of the bandwidth controller exceeds the threshold value are detected by using the flow identification information registered in the flow condition memory and flow statistic information is collected from the detected packets.

5. The information relay apparatus according to claim 4 further comprising a statistic information transmitter which transmits the flow statistic information collected from the flow controller to a flow statistic analyzer connected to the information relay apparatus.

6. The information relay apparatus according to claim 1, wherein the analyzer further comprises a flow detection memory which stores the threshold values in respect of individual combinations of user ID and queue number, wherein the number of packets corresponding to the user ID and queue number is decided as to whether to exceed the threshold value combination by combination.

7. The information relay apparatus according to claim 1, wherein the analyzer further comprises a flow decider which calculates, in respect of the transmitting packet number and packet number corresponding to at least one combination of user ID and packet number, a ratio of the packet number to the transmitting packet number and deciding whether the ratio exceeds the threshold value.

8. The information relay apparatus according to claim 1, wherein the analyzer registers, as the flow identification information, source IP address, destination IP address, destination port address, source MAC address, destination MAC address and DSCP in the flow controller.

9. The information relay apparatus according to claim 1, wherein the analyzer further comprises a flow detection memory which stores the threshold values in respect of individual user ID's and priority degree identification values, and wherein it is decided, in respect of individual combinations of user ID and queue number, whether the packet number corresponding to the user ID and the priority degree identification value exceeds the threshold value.

10. The information relay apparatus according to claim 1, wherein the analyzer further comprises a flow decider which calculates, in respect of the receiving packet number and packet number corresponding to at least one combination of user ID and priority degree value detected by the flow detector, a ratio of the packet number to the receiving packet number and deciding whether the ratio exceeds the threshold value.

11. The information relay apparatus according to claim 1, wherein the analyzer registers, as the flow identification information, source IP address and VLAN ID in the flow controller.

12. The information relay apparatus according to claim 1, wherein the flow controller comprises a flow control decider which adds a flow control label to a packet coincident with the flow identification information registered in advance, and a flow statistic unit which counts the number of packets added with the label.

13. The information relay apparatus according to claim 12, wherein the flow controller further comprises a flow statistic information picking unit which compares the packet number counted by the flow statistic unit with predetermined sampling intervals to decide whether the flow statistic information is to be picked.

14. An information relay apparatus connected to a plurality of circuits to relay packets, comprising:
a receiver/transmitter which receives/transmits packets;
a transmitter which transmits packets;
a bandwidth controller which counts, from the receiving/transmitting packets by the receiver/transmitter, the number of violative packets so determined as to violate predetermined conditions set in correspondence with users transmitting or receiving the packets;
an analyzer which decides whether the number of the violative packets counted by the bandwidth controller exceeds threshold values predetermined in correspondence to the users; and
a flow controller which registers, when the number of the violative packets is so determined as to violate the threshold values by means of the analyzer, information for identifying a flow in which the violative packets are contained and detecting, from the receiving/transmitting packets by the receiver/transmitter, packets corresponding to the registered flow identification information to collect flow statistic information.

15. The information relay apparatus according to claim 14, wherein the analyzer acquires periodically the number of packets counted by the bandwidth controller therefrom and compares it with the threshold value.

16. The information relay apparatus according to claim 14, wherein the flow identification information comprises at least source IP address.

17. A flow statistic information collecting method executed in an information relay apparatus connected to a plurality of circuits to relay packets, comprising the steps of:
transmitting or receiving packets;
executing policing or shaping which transmits or receives packets;
counting the number of packets so determined as to be violative by the policing or shaping;
deciding whether the number of violative packets exceeds a threshold value set for a user corresponding to the violative packets;
registering flow identification information corresponding to the violative packets when the number of violative packets is so determined as to exceed the threshold value; and
collecting flow statistic information corresponding to the registered flow identification information.

18. The flow statistic information collecting method according to claim 17, wherein the step of deciding whether the threshold value is exceeded is executed periodically.

19. The flow statistic information collecting method according to claim 17, wherein the step of collecting said flow statistic information is for sampling, from transmitting or receiving packets, packets corresponding to the registered flow identification information.
